(19) United States
(12) Patent Application Publication
(10) Pub. No.: US 2026/0348762 A1
(43) Pub. Date: Nov. 5, 2026

(54) FIBER OPTIC SKY SENSOR

(71) Applicant: View Operating Corporation, San Jose, CA (US)

(72) Inventor: Robert Michael MARTINSON, Palo Alto, CA (US)

(73) Assignee: View Operating Corporation, San Jose, CA (US)

(21) Appl. No.: 19/458,135

(22) Filed: Jan. 23, 2026

Related U.S. Application Data
(63) Continuation of application No. PCT/US2024/038618, filed on Jul. 18, 2024.
(60) Provisional application No. 63/515,716, filed on Jul. 26, 2023.

(51) Int. Cl. G01J 5/0821; E06B 3/67; E06B 9/24; G01J 1/04; G01J 1/42; G01J 5/04; G02F 1/163

(52) U.S. Cl. CPC G01J 5/0821; E06B 3/6722; E06B 9/24; G01J 1/0403; G01J 1/0425; G01J 1/42; G01J 5/04; E06B 2009/2464; G02F 1/163

(57) ABSTRACT

Fiber optic sky sensor systems and apparatus having fiber optic strands optically coupled (via other fiber optic strands and/or optical couplers) to sensors where proximal ends of fiber optic strands may be located outside building to route light collected from exterior environment to sensors that may be protected inside building.

### CROSS REFERENCE TO RELATED APPLICATIONS

This application is a bypass continuation of International PCT Application No. PCT/US2024/038618 filed on Jul. 18, 2024, which claims benefit of, and priority to, U.S. Provisional Application No. 63/515,716, titled “FIBER OPTIC SKY SENSOR;” filed on Jul. 26, 2023; all of these applications are hereby incorporated by reference in their entireties and for all purposes.

### FIELD

The disclosure relates generally to powering and control of electrochromic (EC) devices. More specifically the disclosure relates to photonically-powered and/or controlled EC devices.

### BACKGROUND

Electrochromism is a phenomenon in which a material exhibits a reversible electrochemically-mediated change in an optical property when placed in a different electronic state, typically by being subjected to a voltage change. The optical property is typically one or more of color, transmittance, absorbance, and reflectance. By way of example, one well known electrochromic material is tungsten oxide (WO₃). Tungsten oxide is a cathodic electrochromic material in which a coloration transition, transparent to blue, occurs by electrochemical reduction.

Electrochromic materials may be incorporated into, for example, windows for home, commercial and other uses. The color, transmittance, absorbance, and/or reflectance of such windows may be changed by inducing a change in the electrochromic material. In other words, electrochromic windows are windows that can be darkened or lightened electronically. A small voltage applied to an electrochromic device (EC) of the window will cause them to darken; reversing the voltage causes them to lighten. This capability allows control of the amount of light that passes through the windows, and presents an opportunity for electrochromic windows to be used as energy-saving devices.

While electrochromism was discovered in the 1960s, EC devices, and particularly EC windows, still unfortunately suffer various problems and have not begun to realize their full commercial potential despite many recent advancements in EC technology, apparatus and related methods of making and/or using EC devices.

### SUMMARY

Electrochromic devices are powered and/or controlled using photonic energy. For example, a photovoltaic power converter is used to supply electricity to an EC device, where the photovoltaic power converter is supplied photons via, e.g., fiber optic technology. Photonic energy is also used as a means to carry communication between various components of a system which includes one or more smart windows. Applications include EC windows, e.g., windows where at least one EC device is incorporated into an insulated glass unit (IGU). In certain embodiments, the photovoltaic power converter is proximate, or integrated with, the IGU, e.g., in the secondary seal, in the spacer, or within the insulated gas space of the IGU. In one embodiment, the photovoltaic power converter is supplied photons via fiber optics. The fiber optics may be supplied with photons originating from a conventional laser, diode laser, sun concentrator, and the like. In certain embodiments, photovoltaic panels supply electrical energy to an electronic driver that energizes the diode laser; the diode laser delivers photons into an optical fiber, which in turn supplies photons to the photovoltaic power converter. Various methods of carrying both power and information using photonic energy in a system which includes one or more smart windows are described.

Benefits related to such methods, apparatus and systems include the ability to deliver power to an EC window via a remotely-located photovoltaic panel over long distances without electromagnetic interference (EMI), radio frequency interference (RFI) electrical cross-talk, line loss of power due to electrical resistance of conventional wiring, information loss due to carrier signal degradation, and the like. Further embodiments and advantages are described in more detail below.

In one aspect of the disclosed embodiments, an electrochromic (EC) window system is provided, including (i) an EC window; (ii) an EC window controller; (iii) a photovoltaic (PV) power converter configured to deliver electricity to the EC window controller; and (iv) an optical fiber configured to deliver a light energy to the PV power converter.

In various embodiments, the light energy may be supplied to the optical fiber from a diode laser. The diode laser may be energized by a driver, the driver receiving power from a photovoltaic array and/or a low-voltage power line of less than about 30 volts. In certain embodiments the light energy is modulated. The modulation may be implemented to achieve a smooth and/or rapid transition between different electrochromic states.

A controller may be used to demodulate the light energy when the light energy received from the optical fiber is modulated. For example, the controller may be configured to decode amplitude modulation in the light energy received from the optical fiber. Additionally, the controller may be configured to determine from the amplitude modulation the polarity of voltage or current to be applied to the EC window. In some embodiments, the controller may include an H-bridge. Alternatively or in addition, the controller may be configured to decode frequency modulation in the light energy received from the optical fiber. For example, the controller may be configured to determine from the frequency modulation the magnitude of voltage or current to be applied to the EC window.

In some cases, the photovoltaic array is positioned more than one meter from the EC window. For example, the photovoltaic array may be positioned on a roof of the building in which the EC window is located, or on the roof of a nearby building. Other configurations are also possible. Photonic energy transmission can be done over long distances with very high efficiency (low power and/or signal loss). The PV power converter may be positioned in a frame around the EC window, or integrated, at least partially, within a secondary seal of the EC window. In some cases, the driver and diode laser are configured to deliver control information. The diode laser may feed to an optical cable, the optical cable running through a splitter, the splitters having a plurality of optical output fibers each configured to deliver control information to each of a plurality of EC window controllers. In some embodiments, the plurality of EC window controllers is configured in a daisy chain format.

In another aspect of the disclosed embodiments, an insulated glass unit spacer is provided, the spacer including a PV power converter. In various implementations, the spacer further includes an EC window controller. In some cases, the EC window controller is configured to demodulate the light energy when light energy received at the window controller is modulated. For example, the window controller may be configured to decode amplitude modulation in the light energy received at the window controller. In certain embodiments, the window controller is configured to determine from the amplitude modulation the polarity of voltage or current to be applied to an optically switchable window in contact with the IGU spacer. The EC window controller may include an H-bridge in various cases. Alternatively or in addition, the window controller may be configured to decode frequency modulation in the light energy received at the EC window controller. In a particular embodiment, the window controller is configured to determine from the frequency modulation the magnitude of voltage or current to be applied to an optically switchable window in contact with the IGU spacer.

In a further aspect of the disclosed embodiments, an EC window IGU is provided, including a PV power converter configured to receive optical energy delivered via fiber optics. In certain embodiments, the PV power converter is positioned, at least partially, in a secondary seal of the IGU. The EC window IGU, in some implementations, may have no electrical wiring traversing a primary seal of the IGU. Further, the EC window IGU may include an EC window controller positioned, at least partially, in a secondary seal of the IGU. In some embodiments, the EC window controller resides entirely within the secondary seal.

The EC window controller may be configured to perform a variety of functions. In some cases, the EC window controller may be configured to demodulate optical energy when optical energy received at the EC window controller is modulated. For example, the EC window controller may be configured to decode amplitude modulation in the optical energy received at the EC window controller. The EC window controller may also be configured to determine from the amplitude modulation the polarity of voltage or current to be applied to the EC window IGU. Further, the EC window controller may be configured to decode frequency modulation in the optical energy received at the EC window controller.

In another aspect of the disclosed embodiments, an optically switchable device system is provided, including (i) an optically switchable device including bus bars; (ii) a PV power converter configured to apply a voltage to the bus bars; and (iii) an optical fiber configured to deliver a light energy to the PV power converter. The system may also include a plurality of optical fibers connected with a light source, where the optical fibers are configured to delivery light energy to each of a plurality of PV power converters coupled with each of a plurality of optically switchable devices.

In some embodiments, the optically switchable device system further includes an optically switchable device controller that defines the voltage and/or current applied to the bus bars by the PV power converter. In a particular implementation, the optically switchable device controller is configured to independently control the voltage and/or current applied to each of a plurality of optically switchable devices. The optically switchable device controller may be configured to demodulate light energy when light energy received at the optically switchable device controller is modulated. For example, the controller may be configured to decode amplitude modulation in the light energy received at the optically switchable device controller. The controller may be configured to determine from this amplitude modulation the polarity of voltage or current to be applied to the optically switchable device. Alternatively or in addition, the optically switchable device controller may be configured to decode frequency modulation in the light energy received at the optically switchable device controller. In certain embodiments, the system may further include a splitter that splits light energy between a first path that delivers light energy to the PV power converter and a second path that delivers light energy to the optically switchable device controller.

Certain embodiments pertain to a system having a housing configured to attach or mount to an exterior portion of a building and a plurality of fiber optic strands at least partially positioned in the housing. The system also includes a plurality of lenses coupled to, within, and/or adjacent to the housing, wherein each lens is coupled to a proximal end of a corresponding fiber optic strand. In addition, the system includes one or more sensors, wherein distal ends of the fiber optic strands are configured for optical communication with the one or more sensors.

Certain embodiments pertain to an apparatus having a plurality of fiber optic strands and plurality of lenses wherein each lens is coupled to a corresponding fiber optic strand. The proximal end of each fiber optic strand is located exterior to a building and distal end of each fiber optic strand is configured for optical communication with one corresponding sensor of a plurality of sensors, the plurality of sensors located inside the building.

Certain embodiments pertain to an apparatus having a housing configured to attach or mount to an exterior portion of a building and a plurality of first fiber optic strands at least partially positioned in the housing. The plurality of first fiber optic strands is configured to receive radiation from fields-of-view about different sets of azimuthal and altitudinal angles, wherein the first fiber optic strands have distal ends configured for optical communication with a plurality of photosensors inside the building.

Certain embodiments pertain to an apparatus comprising a printed circuit board and one or more sensors disposed on the printed circuit board. The one or more sensors is configured for optical communication with one or more fiber optic strands.

These and other features will be described below with reference to the associated drawings.

### BRIEF DESCRIPTION OF THE DRAWINGS

FIGS. 1A-B depict the basic structure of an electrochromic window device.

FIG. 2 shows an exemplary electrochromic-photovoltaic (EC-PV) system where photonic power transmission is used to supply energy from the PV device to EC windows.

FIG. 3 illustrates an embodiment of an electrochromic device which transforms light energy to electrical energy at or within an insulated glass unit.

FIG. 4 shows an embodiment of an insulated glass unit having a pig tail connector.

FIG. 5 depicts a close-up cross sectional view of an electrochromic insulated glass unit having electrical wiring that passes through a primary and a secondary seal of the insulated glass unit.

FIG. 6 depicts a close-up cross sectional view of an electrochromic insulated glass unit having an optical fiber that passes through a secondary seal of the insulated glass unit, according to a disclosed embodiment.

FIG. 7 shows an electrochromic insulated glass unit having wiring enclosed in a spacer positioned proximate the periphery of the insulated glass unit.

FIG. 8A presents a block diagram of a local controller at the optically switchable device in accordance with one embodiment.

FIG. 8B presents a block diagram of an electrochromic window system that utilizes upstream data transfer in accordance with certain embodiments.

FIG. 9 presents a block diagram of an upstream controller for providing instructions to multiple downstream optically switchable devices in accordance with one embodiment.

FIG. 10 is an illustration of cross-sections of different types of lenses that may be used as collection lenses in a fiber optic apparatus, according to various implementations.

FIG. 11 depicts a schematic diagram of a fiber optic sky sensor system, according to various implementations.

FIG. 12 depicts a schematic diagram of a fiber optic apparatus with a cylindrical housing, according to implementations.

FIG. 13 depicts a schematic diagram of a conduit of a fiber optic apparatus, according to various implementations.

FIG. 14 depicts a photograph of schematic diagram of a fiber optic apparatus with a cylindrical housing, according to an implementation.

FIG. 15 depicts a schematic diagram of a fiber optic apparatus with a housing having a generally conical frustrum shape, according to implementations.

FIG. 16 depicts a schematic diagram of a fiber optic apparatus with a housing having three sections, according to implementations.

FIG. 17 depicts a schematic diagram of a fiber optic apparatus with a housing having a generally conical frustrum shape, according to implementations.

FIG. 18 depicts a schematic diagram of a fiber optic apparatus with a housing having a hemispherical shape, according to implementations.

FIG. 19A depicts an illustration of a sky dome model, according to implementations.

FIG. 19B depicts an illustration of a two-dimensional (2D) projection of a sky dome model, according to implementations.

### DETAILED DESCRIPTION

An “optically switchable device” is a thin device that changes optical state in response to electrical input. It reversibly cycles between two or more optical states. Switching between these states is controlled by applying predefined current and/or voltage to the device. The device typically includes two thin conductive sheets that straddle at least one optically active layer. The electrical input driving the change in optical state is applied to the thin conductive sheets. In certain implementations, the input is provided by bus bars in electrical communication with the conductive sheets.

While the disclosure emphasizes electrochromic devices as examples of optically switchable devices, the disclosure is not so limited. Examples of other types of optically switchable device include certain electrophoretic devices, liquid crystal devices, and the like. Optically switchable devices may be provided on various optically switchable products, such as optically switchable windows. However, the embodiments disclosed herein are not limited to switchable windows. Examples of other types of optically switchable products include mirrors, displays, and the like. In the context of this disclosure, these products are typically provided in a non-pixelated format.

An “optical transition” is a change in any one or more optical properties of an optically switchable device. The optical property that changes may be, for example, tint, reflectivity, refractive index, color, etc. In certain embodiments, the optical transition will have a defined starting optical state and a defined ending optical state. For example, the starting optical state may be 80% transmissivity and the ending optical state may be 50% transmissivity. The optical transition is typically driven by applying an appropriate electric potential across the two thin conductive sheets of the optically switchable device.

### EC Windows

For many years the building industry has been burdened with two opposing trends. The first trend, the increasing demand for glass over other construction materials, is driven by a number of factors. Glass buildings are currently viewed as aesthetically more pleasing and more modern. Glass buildings also provide occupants with a number of advantages: better productivity, more natural lighting, absenteeism reduction, and improved comfort. Lighting engineers strive to create light sources which mimic natural light. The second trend, increased demand for energy efficiency, is conventionally at odds with the first trend. While increased use of windows can lower lighting requirements, it can also dramatically add to the cooling requirements of the building and negatively impact productivity and comfort due to increased glare. For example, commercial buildings use a large portion of public energy resources and yet a very large portion of that energy is wasted due to overburdening heating, ventilation and air conditioning (HVAC) systems due primarily to very poor energy efficiency of conventional windows. Conventional windows are simply not energy efficient and, at the same time, require expensive window treatments to reduce glare. In some cases, these window treatments negatively impact occupant view, thus defeating the purpose of having a window.

Architects and builders have needed an energy efficient window that could accommodate changes in the environment and the needs of the building occupants by dynamically altering its optical properties to control the amount of sunlight and heat entering the building. One answer to this need is electrochromic window technology.

In the arena of window glazings, electrochromic coatings may serve to control the amount of light and heat passing through the glazing by user controlled applied electrical potentials across the optical device. Because electrochromic windows can be tinted or made clear via a small applied voltage, this technology has the potential to significantly reduce the amount of room heating or air conditioning, and it can also be used for privacy. Since the amount of glass currently used for various types of windows (e.g., skylights, aircraft windows, residential and commercial building windows, automobile windows, etc.) is on the order of one billion square meters per year, the potential amount of energy savings if these are converted to EC windows is substantial.

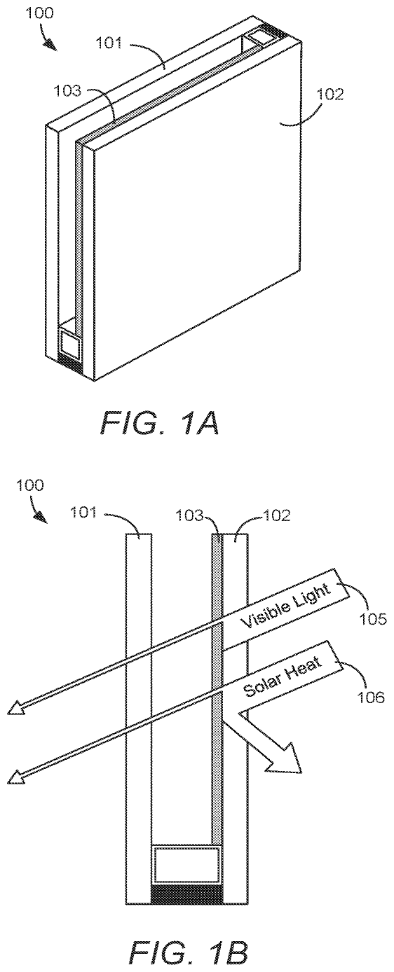

FIGS. 1A-B illustrate the basic principle of electrochromic window technology. A typical electrochromic (EC) window 100 uses an insulated glass unit (IGU) construct, just as a conventional window. The difference is that an EC window 100 has an electrochromic thin film coating 103 on one (or both) lites 101 and 102 of the IGU. The EC coating 103 can tint or clear upon application of a small electrical potential applied across the EC coating. When tinted, the EC coated lite 102 can block visible light 105 to provide occupant comfort, but also block solar heat gain 106 and therefore reduce cooling burden on HVAC systems. Also, there is no need for conventional shades or window treatments.

### Conventional EC-PV Systems

One difference between EC windows and conventional windows is the wiring required to deliver electricity to the EC devices for switching from clear to tinted, and back again. Builders must integrate these wires into the framing systems of the windows. The wires from the EC windows eventually are connected to a source of power, e.g., a low-voltage run that ultimately is connected to a higher-power line source. In these low-voltage runs of wire, there are associated issues, e.g., voltage drop (line loss) due to the sometimes long lengths of wire required to incorporate a large number of windows in a building. Thus, it has been described as desirable to integrate a photovoltaic power source with the EC window in order to have a local power source for the EC device. This combination is also deemed desirable because, even though EC windows use little power, the EC window would be self-powered and thus be a net zero energy installation on its own, and collectively save even more energy on HVAC.

A combination of electrochromic and photovoltaic functions (from herein, “EC-PV” systems) may be employed in a system that, as a whole, is passive, i.e., when the sun is shining the power generated by the PV system is used to power the transitions of the EC system. EC-PV systems may take various approaches.

In one approach, a transparent PV coating is combined with an EC coating in a tandem fashion. This EC-PV system has many problems, primarily due to issues associated with the PV coatings. For example, transparent PV technology is not truly transparent; there is haze and an associated loss of light transmission when the PV coating lies between the sun and the EC coating (as is a typical configuration). The transmissivity in the clear state of the EC coating is reduced due to the reflections from multi-layer construction and absorption of the PV coating. As an example, dye sensitized PV coatings (e.g., dye sensitized TiO2) have associated absorption due to the dye component of the system. Another issue with this type of system is if the EC coating is between the sun and the PV coating, when the EC coating tints, the PV loses power, so it can operate only in a self-limiting fashion. Also, transparent PV technology is not robust. Typically, transparent PV coatings are organic-based and therefore may break down in the harsh conditions of solar radiation and heat. Moreover, although many EC systems require relatively little power, current transparent PV technology simply does not produce sufficient power for most EC device needs-the technology is not yet sufficiently efficient. Further complicating this approach is integration of the EC and PV coatings in the IGU. If combined on a single lite, there are often compatibility issues and integration issues related to transferring power from the PV to the EC coating, extra wires, etc. If configured on separate lites of an IGU, the intercompatibility issues between the EC and PV technology may be overcome, but the integration and wiring issues remain. Put simply, the tandem EC-PV design is more complex to construct and engineer than an EC device alone, no matter how one configures the PV.

Another approach places conventional, more well-established, reliable and robust, non-transparent PV cells proximate the EC coating or situated in what would otherwise be a viewable area of the EC window. In this approach, PV cells are placed in the window frame, close to it, or share the same space as the EC device, thus blocking a portion of the viewable area. This blockage results in less solar control and poor aesthetics for the viewer. Smaller PV cells could be used to decrease the negative visual impact of the PV cells, but this approach also decreases the amount of electrical power generated, which may be insufficient to power EC device transitions. Also, the aforementioned integration issues remain, with some additional issues, including reworking or designing new framing systems, customer rejection due to poor aesthetics and the like.

### Photonic Powered EC Windows

The present disclosure describes solutions to the limitations of conventional EC-PV systems. It addresses challenges arising from the integration of EC and PV technologies. Both EC and PV technologies require large amounts of area-EC technology because it is designed to cover the viewable area of windows, and because occupants and architects especially prefer large windows; PV technology because it is used to harvest solar energy, and in order to harvest more energy, more area is required. The goals of the two technologies are inherently at odds with each other, both from an aesthetic perspective and an engineering perspective.

From an aesthetic perspective, the goal of EC window technology is to cover large areas of viewable area with beautifully-tinting glass to enhance occupant comfort and experience—people like the look of, and to look through, unobstructed (high-clarity) windows. The goal of PV technology is to cover large amounts of area in order to capture as much solar energy as possible; aesthetics are completely beside the point—PV panels are typically placed on the roof or in remote locations, not only to capture more light using unobstructed geography, but also because people do not tend to find them particularly attractive and don't want (or need) to see them. This aesthetic issue could be overcome if a truly transparent (and efficient, reliable and robust) PV technology can be achieved for use in a tandem EC-PV system. But even if the latter (laudable) goal is achieved, there are still engineering issues related to integration of the PV and EC technologies.

As described above, from an engineering standpoint, it is difficult to integrate EC and PV technology in, or proximate, an IGU or the framing system of the IGU. Besides the above described issues with integration, the PV cells used in these systems are simply not large enough to generate sufficient power for the EC system to effectively switch. Making the PV cells larger only exacerbates the aesthetic and integration issues. Even if one were to find an elegant solution to overcome the myriad of engineering issues, the poor aesthetics of these systems put a damper on demand—simply put, they are clunky and unattractive.

If a PV system is not located in close proximity to the EC system, there is significant line loss due to transmission over conventional low-voltage wiring systems in buildings and other structures employing EC windows. Additionally, current carried over such lines is susceptible to electromagnetic interference, radio frequency interference, and inefficiency of transmitting electricity over long spans of wire.

The disclosed embodiments overcome these issues by delivering energy to an EC device using photonic power. For example, photonic power may be beamed through an optical fiber or through space (e.g., via a laser beam) and into a photonic power converter which converts the light energy to electricity, which is used to transition the EC device (e.g., via an EC controller).

In certain embodiments, the photovoltaic power converter is proximate or integrated with the IGU, e.g., in the secondary seal, in the spacer, and/or within the insulated gas space of the IGU. In certain embodiments, the photovoltaic converter may span at least the width of a secondary seal and a portion (or all) of the width of the spacer. In one embodiment, the photovoltaic power converter is supplied photons via fiber optics. The fiber optics may be supplied with photons from a conventional laser, diode laser, sun concentrator, or the like. In certain embodiments, one or more photovoltaic panels supply electrical energy to an electronic driver that energizes the diode laser; the diode laser delivers photons into an optical fiber, which in turn supplies photons to the photovoltaic power converter. The photovoltaic power converter converts the photons back to electrical energy for transitioning the EC window. As described in more detail herein, the photons may be modulated in order to, e.g., carry information used to control the EC window.

Benefits related to such methods, apparatus and systems include the ability to deliver power and instructions to (and from) an EC window via a remotely-located photovoltaic panel over long distances without electromagnetic interference (EMI), radio frequency interference (RFI) electrical cross-talk, line loss of power due to electrical resistance of conventional wiring, and the like. Further details are described below in relation to specific embodiments, although the scope of the invention is not intended to be limited in this way.

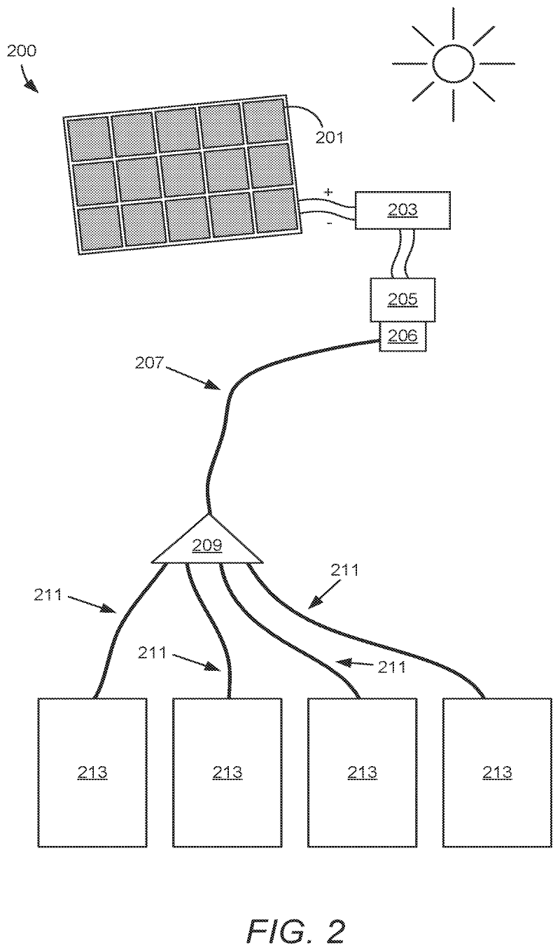

FIG. 2 depicts an exemplary EC-PV system 200 where photonic power transmission is used to supply energy from a PV system to EC windows. A solar panel 201 is connected to a voltage controller 203 so that the correct voltage can be applied to an electronic driver 205. Electronic driver 205 may use only a small fraction of the output of the solar panel, in this way many such drivers may be powered by the solar panel, or, e.g., such drivers may be supplied by various solar panels. The driver 205 powers a concentrated light source 206. In other words, the driver 205 and light source 206 work together to convert electrical energy into optical energy. In certain cases, the driver 205 and light source 206 are collectively referred to as a “power module” (which is distinct from a photonic power module, which includes additional elements as described herein). In one example, the concentrated light source 206 is a laser, e.g., a diode laser. The diode laser output is delivered through optical fiber 207 to (in this example) a splitter 209, which in turn delivers photonic energy via optical fibers 211 to a number of IGU's 213 containing EC devices. The photonic power may be delivered with relatively little loss or interference over distances that are encountered in various types of buildings and vehicles. In this example, in or proximate each IGU 213, is a photovoltaic power converter (not shown), which converts the photons delivered to it by the optical fiber 211 into electricity which is used to drive the EC device(s) of the IGU 213. The electrical power would typically be delivered from the photovoltaic power converter to an EC window controller.

The driver 205, light source 206, optical fibers 207, optional splitter 209, optical fibers 211, and photovoltaic power converters may collectively be referred to as a photonic power module (PPM). Further, the PPM may include a voltage controller. In some cases, the PPM may be simpler, consisting of a driver, light source, a single optical fiber, and a single photovoltaic power converter. Various implementations are possible depending on the desired design and the number of EC devices being powered by the PPM.

Photonic power modules are commercially available from various manufacturers and vendors including, for example, JDS Uniphase Corporation (“JDSU”) of Milpitas, CA. In one example, a power module such as one obtained from JDSU (e.g., a PPM-5 Photonic Power Module) requires an input of only a few volts (e.g., about 5 volts) of direct current (DC), which can easily be delivered from a solar cell (as depicted in FIG. 2). Such Photonic Power Modules (PPM's) are typically configured as isolated power supplies. As noted above, an exemplary PPM includes a laser module with a driver, a fiber patch cord to transmit the laser energy, and a photovoltaic power converter to convert the laser energy to electrical energy. For example, such PV power converters have outputs in the range of about 2-15 volts—this is well within the operating voltage of many EC devices, particularly EC windows, even large size EC windows (for example, View, Inc. of Milpitas, CA, produces all solid state and inorganic EC windows as large as 60″ by 120″ that operate on as little as a few volts). Also, the lifespan of a diode laser is on the order of about 70,000 hours at 40 degrees C, since the EC window is powered only intermittently, the diode should last on the order of about 15-20 years. This is commensurate with the lifespan of a robust EC window.

With solar panels giving an output of around 75-350 watts for a 2×4 ft panel, there is more than enough power to energize one or more photonic power modules. For example, at 9watts/ft2, such a panel may be used to surround each individual frame of the IGU.

However, since there is a large base of established solar panels on the roofs of residential and commercial buildings, certain implementations tap this source of energy, when available. As described above, powering EC devices via photonics may use only a small fraction of the output of a particular solar panel. This provides flexibility for installing, e.g., retrofitting, photonic powered EC windows in any number of existing PV-supplied buildings.

Alternatively to PV power, e.g., in the event such buildings do not have a solar panel installation, the energy delivered to the driver of the photonic power module can be supplied by in-house electricity or even by a bank of batteries. In one embodiment, line voltage is used to energize the driver/light source, e.g., in a convenient run of low-voltage line, and fiber optic cable is used to deliver the power from the light source to the EC window(s). In one embodiment, a plurality of EC window controllers and optionally I/O controllers are daisy chained together to create networks of EC windows, for automated and non-automated EC window applications. This configuration is described in U.S. patent application, Ser. No. 13/049,756, filed Mar. 16, 2011, titled “Multipurpose Controller for Multistate Windows,” which is incorporated by reference herein. In this embodiment, a plurality of photonic power modules is used to carry power to the EC window controllers.

Regardless of the type of power source used to energize the photonic power module, the power source can be remotely located from the EC windows and still transmit power without the issues associated with conventional power transmission. For example, according to its specifications, the PPM-5 can deliver between about 0.5 to 1 W of power in the 750 to 850 nm and 900 to 1000 nm range, depending on the laser source selected. Power can be delivered over distances of 0.5 km or greater using 62.5 um or 100 um multimode optical fiber. Since power can be transported by fiber optic up to 500 m (or 1500 feet) with little loss, there will be little loss of power for window applications for all residential building and most commercial buildings. For example, for a multimode fiber with an 850 nm source, the loss is about 3 dB per km, corresponding to a loss of about 1.5 dB over a distance of 500 m. This loss represents about 30% of the total power transmitted (70% of transmitted power reaches the load). Similarly, for a singlemode fiber with a 1550 nm source, the loss is about 0.4 dB per km, which corresponds to a loss of only 0.2 dB over 500 m. In this case the efficiency of power transmittal may be much greater. In some embodiments, the PV power source may be located outside the building housing the EC windows. PV power may be generated in a common area for multiple buildings or it may be generated in one building and shared with one or more neighboring buildings.

Also, e.g., as depicted in FIG. 2, from a single fiber optic 207, the light may be broken down into sub-fiber conduits 211 so that multiple IGU's 213 may be powered off of an individual driver 205/light source 206 pair. A splitter 209 (known in the industry as a “tree splitter” and commercially available from a number of fiber optic suppliers) may be used to “split” the incoming light source into multiple outlet optical fibers 211. This split allows multiple EC windows 213 to receive power from a single driver 205/light source 206. Also, fiber optic cable is much easier to handle and install than electrical wiring, saving time and simplifying installation of EC windows. Use of fiber optics also protects installers from having to handle electrical wires that might be energized inadvertently, thereby making the installation process less dangerous or problematic. Moreover, optical fiber simplifies the configurations for power delivery to the EC window controller as well as delivery of power to the EC device itself. This concept is explained in more detail below.

In some embodiments, the solar panel, voltage controller, driver, and laser are replaced with a solar light concentrator, which delivers light of appropriate wavelengths to the optical fiber.

In various embodiments, an EC controller is energized via photonic energy, and energy may also be delivered from the controller to the EC device via photonic energy.

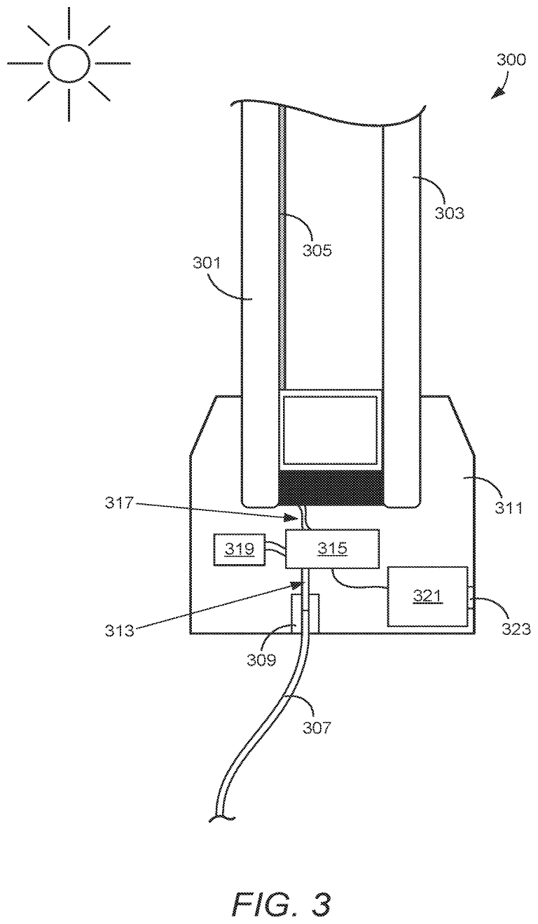

FIG. 3 depicts an embodiment showing how power can be transformed from light to electricity at or within an IGU. The IGU 300 includes a first pane 301 and a second pane 303. In this embodiment, the first pane 301 faces toward the outside of the building, and the second pane 303 faces the interior of the building. The interior surface of the first pane 301 includes a layer of electrochromic material 305. In certain embodiments, an incoming fiber 307 is placed at normal incidence at, e.g., an IGU in window frame 311. The actual angle at which the incoming optical fiber 307 is oriented is not critical, so long as it aligns with the interior optical fiber 313. In some cases, a transparent window may be present where incoming optical fiber 307 meets the IGU. The transparent window may have an anti-reflective coating on it.

The incoming optical fiber 307 is aligned with an interior optical fiber 313 that is attached to the photovoltaic power converter 315. In certain embodiments, optical fibers 307 and 313 are aligned and optically coupled via a plug and socket architecture, 309, as are commercially available. In the embodiment described in relation to FIG. 3, the photovoltaic power converter 315 is hidden within the window frame 311, which holds IGU 300. Power converter 315 delivers its electrical output to wires 317, which are electrically connected with bus bars (not shown), which power the transition of EC coating 305. Optionally, a storage device 319, e.g., a trickle charge battery, is included. Storage device 319 can aid operation, for example when a logic device 321 (e.g., a controller implemented on an embedded micro controller, programmable logic controller, or application specific integrated circuit) includes instructions to turn off external power to the EC system or during the colored holding period when minimal power is required to offset leakage current through the EC device, or to store energy for later use. In some implementations, the controller may include systems on a chip (SOCs), for example from the Kirkwood series of processors from Marvell Semiconductor, Inc. of Santa Clara, CA, or from the PIC series from Microchip Technology of Chandler, AZ. In one embodiment, controller 321 receives input via an infrared (IR) signal, e.g., from a touch pad from the interior of the room where the IR signal passes through an IR transparent window 323, e.g., in frame 311. A remote controller may also provide instructions to controller 321.

In the depicted embodiment, at IGU 300, incoming optical fiber 307 stops just short of, or abuts, fiber 313 of the hermitically sealed IGU 300. The light is focused on an aligned fiber 313 which catches all the light emanating from the incoming optical fiber 307, which is supplied by a laser (not shown). Fiber 313 is connected to PV power converter 315. For example, a power converter from JDSU can have electrical output in the range of between about 2 and 12 volts. In particular, a PPC-4E from JDSU delivers up to about 4 volts with an electrical power of up to about 500 mW. Higher power systems up to about 5 watts can be obtained by using multiple lasers and combining the output at the end of the fibers.

Note that an optical window or optical socket can be placed on different surfaces of the window frame. In some embodiments the transparent window or optical socket is on a different face of the frame, for example on the bottom surface where the optical fiber delivers light through the bottom of the frame, or on the top surface of the frame where the optical fiber delivers light through the top of the frame (in which case the power converter 315 and associated elements may be located in a top portion of the frame). The optical window or optical socket need not be on the same surface of the frame as, e.g., the IR window for the EC controller, but in one embodiment the optical input is on the same side of the window frame as other inputs.

An EC device, depending on the size of the window and other parameters, may operate at between about 1 μA/cm² and about 60 μA/cm². For example, a 2 ft×2 ft window has an area of about 3,600 cm². Therefore, near the maximum current limit the window should consume about 50×10−6 amps/cm2×3,600 cm²=180×10−3 amps or 180 milliamps. Using a power module at 2 volts at 500 milliwatts power, there is 250 milliamps of current available, which is more than enough to operate such a window. For windows that only use 10 μA/cm², the total current on a 2 ft×2 ft window would be 80% lower, allowing 5 windows to easily operate off of a PPM-5 Photonic Power Module system. Larger EC windows may require a dedicated photonic power module, depending on the efficiency and output of the PPM. Lower currents can be used, e.g., if slower EC device transitions are acceptable. When fully tinted, the current necessary to hold the tinted state is very low and will approximate any leakage current. During this stage, the power continues to collect in the auxiliary battery as shown in FIG. 3.

The EC system can be of any type, although in one embodiment the design is as described in pending U.S. patent application publications, US 2011/0267675, US 2011/0267674, US 2011/0266138, US 2011/0266137 and US 2011/0249314, each assigned to View, Inc., of Milpitas, CA, and each of which is herein incorporated by reference. The EC coatings can be on any transparent substrate, such as glass, rigid plastic or flexible plastic. In the case of flexible plastic, the EC coatings can be suspended in an IGU or laminated to the glass face on the interior surface of the exterior pane of the IGU.

A local EC window controller and associated photovoltaic power converter can be in the frame of the window, or it can be wholly or partly integrated between the panes of the IGU, e.g., in the secondary seal of the IGU. Optical fiber not only simplifies installation by obviating the need for electrical wiring, but also can simplify delivery of power to the IGU regardless of the configuration of the controller. This is described in more detail below.

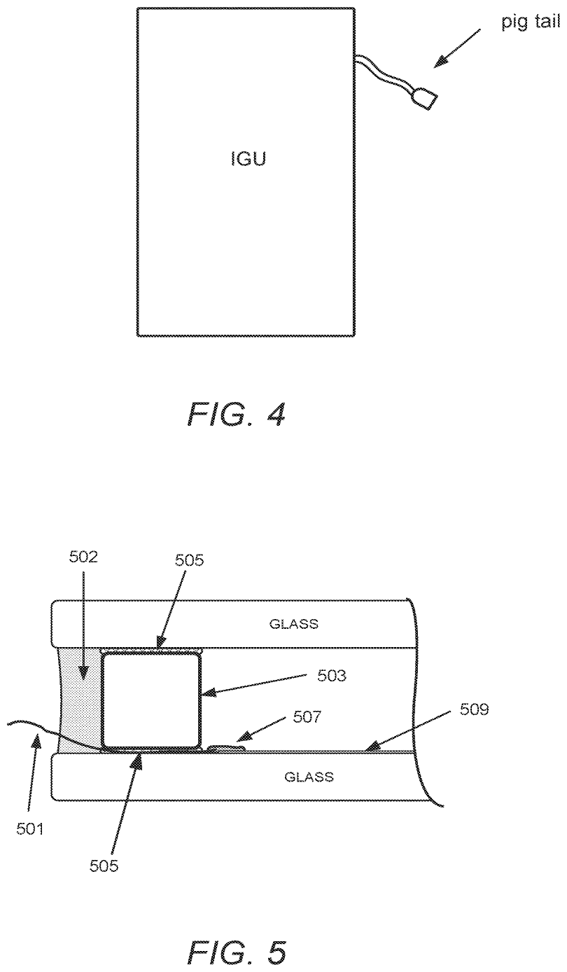

As depicted in FIG. 4, in some EC systems, electrical wiring runs into a window frame and to a “pig tail” connector which is used to deliver power to the bus bars of the EC device in the IGU. The pig tail is part of the wiring harness of the IGU. The IGU may not use a pig tail, but rather may have a plug integrated into the secondary seal so as to avoid wires protruding out of the IGU prior to installation. The EC window controller delivers power to the EC device via a pig tail or, in some instances, the window controller, or one or more components thereof and the wiring harness, is integrated into the IGU itself. Thus a pigtail may be used to deliver power to the EC controller. Such “onboard” EC controllers are described in U.S. Pat. No. 8,213,074, titled “Onboard Controller for Multistate Windows,” which is incorporated by reference herein. Further wiring and/or controller configurations are described in U.S. patent application Ser. No. 13/326,168, filed Dec. 14, 2011, and titled “CONNECTORS FOR SMART WINDOWS,” which is herein incorporated by reference in its entirety. The embodiments described in the Ser. No. 13/326,168 application may be powered by the photonic power means disclosed herein.

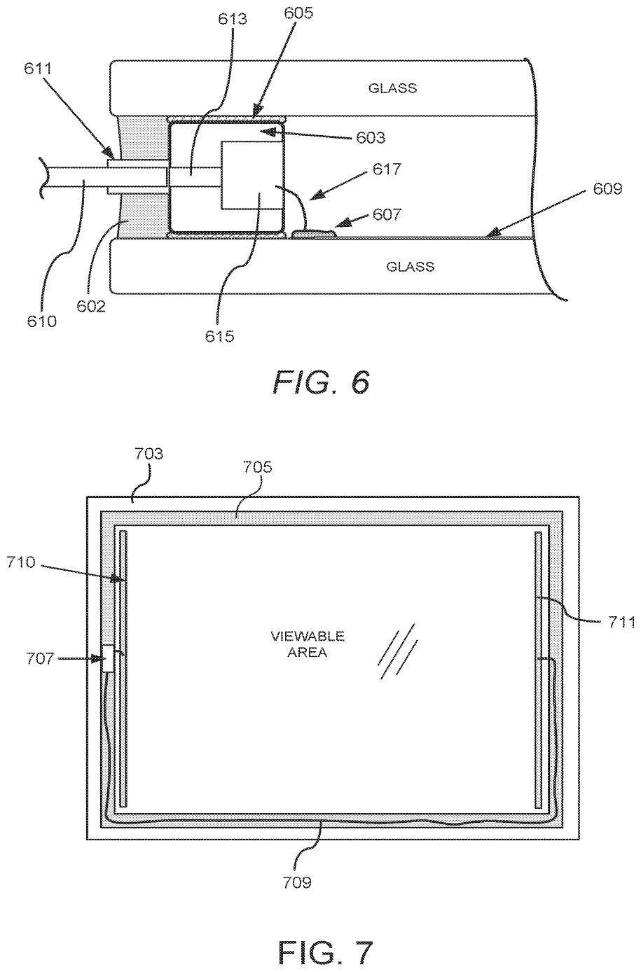

No matter the configuration of the controller, conventional systems have electrical wires that must traverse the secondary and primary seal of the IGU. This is depicted in FIG. 5. FIG. 5 depicts a partial cross-section of a conventional EC window IGU. As illustrated, the electrical supply wire 501 must pass through the secondary seal 502 and the primary seal 505 and in order to supply the bus bar 507 with power. The primary seal 505 is positioned between the spacer 503 and the glass (i.e., the sealant between the spacer 503 and glass is the primary seal 505). The bus bar 507 applies the voltage used to change the optical state of the electrochromic layer 509. This wire traversal may compromise primary seal 505. Spacers for improving this configuration are described in U.S. patent application Ser. No. 13/312,057, filed Dec. 6, 2011, and titled, “Improved Spacers for Insulated Glass Units,” which is incorporated by reference herein. Optical fiber technology and photonic power conversion can obviate the need for wires traversing the primary seal. An exemplary embodiment is described below in relation to FIGS. 6 and 7.

In certain embodiments, the optical fiber is coupled via an optical conduit in the spacer to the PV power converter, which resides in the spacer of the IGU. This is illustrated in FIG. 6. The fiber optic 610 runs through the secondary seal, 602, (via an optical fiber socket 611) and to an optical fiber coupler (light conduit) 613. For example, optical fiber couplers and hermitically sealed feed through units are commercially available from Fiberdesign, B. V. of the Netherlands or from Accu-Glass Products, Inc. of Valencia, CA. The PV power converter 615 is located in the spacer 603 of the IGU. The wiring 617 to the bus bars 607 runs from the PV power converter 615 to the bus bars 607. The bus bars 607 apply a voltage to the electrochromic film 609. In one example, fabrication of the IGU may include applying primary sealant, soldering the bus bar wires emanating from the spacer to the bus bars, and hermetically sealing the IGU. The design shown in FIG. 6 is preferable to the conventional design shown in FIG. 5 because there is no wire or other conduit traversing the primary seal. Thus, there is less risk that the primary seal will become compromised over the lifetime of the window.

As shown in FIG. 7, wiring 709 for the distal bus bar 711 (i.e., the bus bar opposite the bus bar 710 proximate the PV power converter 707) can be run inside the spacer 705, which is positioned inside of the secondary seal 703. By having electrical wire 709 only inside the spacer 705, and emanating only from the surfaces of the spacer within the primary seal, a more robust IGU seal is realized. One of ordinary skill in the art would appreciate that the PV power converter can be configured so that it is equidistant from each of the bus bars 710 and 711 such that there is matched wiring in the spacer 705.

Various advancements in window design including improved spacer/IGU configurations, bus bar and wiring placement (e.g., designs having all bus bars and wiring positioned outside the window's viewable area, for example in a primary seal/under a spacer), and improved bus bar contacts are described in the following Patent Applications: U.S. patent application Ser. No. 13/456,056, filed Apr. 25, 2012, and titled “ELECTROCHROMIC WINDOW FABRICATION METHODS”; U.S. patent application Ser. No. 13/312,057, filed Dec. 6, 2011, and titled “SPACERS FOR INSULATED GLASS UNITS”; and PCT Application No. PCT/US2012/068950, filed Dec. 11, 2012, and titled “CONNECTORS FOR SMART WINDOWS”, each of which is herein incorporated by reference in its entirety.

The PV power converter may be integral to, or coupled with, an onboard EC window controller located, at least partially, in the secondary seal of the IGU. In one embodiment, both the PV power converter and the EC window controller are partially or fully within in the secondary seal. In another embodiment, both the EC window controller and the PV power converter are housed within the spacer. In another embodiment one of the PV power converter and the EC window controller is in the spacer while the other is in the secondary seal. One or more components of the EC window controller may be in the spacer and/or the secondary seal. Using such configurations (and configurations like those described in relation to FIGS. 3, 6, and 7), the need for electrical wiring within the spacer may be minimized or avoided altogether. In other words, light energy, rather than electrical energy, traverses the spacer. In any of these embodiments, whether the components are in the secondary seal and/or in the spacer, only an optical fiber need be attached to the IGU, greatly simplifying installation of EC windows. In such embodiments, the power and communication runs between a light source and the EC windows may be as simple as a single optical fiber. The optical fiber leading to the EC window may then couple with a receiving optical fiber as described above.

In certain embodiments, the light transmitted through the fiber optic to the IGU is modulated to deliver power at a specified frequency to the EC controller. This modulated power can be used to drive the EC device in a certain way, e.g., rather than, or in addition to, having the EC controller modulate the power.

In various embodiments, control information is provided photonically. The control information controls some aspects of the operation of the photonically powered electrochromic device. It may not be sufficient to simply deliver power from a photonic source to the electrochromic device. In some implementations, the control information is provided to the electrochromic device to effectuate the transition. Thus photonic energy is used both to transfer power and deliver and/or receive information. In certain embodiments, photonic powering and communication are used in combination with wireless (WiFi) communication.

Examples of the control information that can be provided photonically include the magnitude of the applied voltage, the polarity of the applied voltage, and additional logic such as daily periods of time when the window must be tinted, the address of optically switchable devices such as electrochromic windows receiving such control information.

Other examples of the third type of information include schedules where different windows under control of an upstream photonic driver tint at different times and/or for different durations. For example, the default condition in a bank of windows involves tinting upper windows for two hours and tinting the bottom windows all day. As another example, the logic may require a window tint no more than a certain number of hours per day (e.g., 8 hours). The prior examples describe “downstream” data transfer (e.g., to the EC controller). It is also possible to implement “upstream” data transfer in some implementations. In this case, information sent back upstream may relate to the current conditions of the EC device such as the actual voltage and current applied to the device, temperature, and operating conditions or other status signals derived from the micro controller (e.g., EC is tinting or clearing, is tinted to 20%, 40% etc.) In certain embodiments, the optically switchable device controller contains logic for interpreting the control information and applying the appropriate voltage to the window at the appropriate time. In some embodiments, the logic corresponds to logic element 321 in FIG. 3. Sometimes the logic is implemented as controller hardware locally present at the optically switchable device. Other times, the logic is partially implemented as software for controlling a processor. In general, the logic serves as a controller for controlling the operation of an associated optically switchable device.

Control information must be interpreted locally at the optically switchable device and/or remotely at an upstream controller responsible for dictating the transitions of multiple optically switchable devices under its control. In some cases, control information such as the magnitude of a voltage required to drive a device transition and the polarity of the voltage is encoded upstream but the information is separately decoded locally at the device. For example, the drive voltage magnitude is decoded by one mechanism and the voltage polarity is decoded by a different mechanism.

In certain embodiments, control information is delivered photonically to the optically switchable device undergoing transitions. In other embodiments, the control information is received by the optically switchable device local controller by non-photonic means. Such means may be conventional electrical wiring or wireless media such as a Bluetooth connection, etc. In cases where photonic delivery is employed, the control information may be conveniently delivered together with the light beam responsible for powering the optically switchable device transitions.

Within the context of photonic transmission of control information, three embodiments will now be presented. These embodiments differ from one another in how types of control data are encoded upstream in a light beam. The types of control information that are encoded differently or at least potentially encoded differently include (1) the polarity of the voltage applied to the optically switchable device, (2) the magnitude of the voltage applied to the optically switchable device, and (3) other types of logic used by the optically switchable device. Types of encoding include frequency modulation and amplitude modulation. Either of these can be applied to a source of photonic power, whether that source is a laser, a solar collector, etc.

First embodiment-The source of photonic power contains no frequency modulation (i.e., the source delivers constant photonic power), but it is amplitude modulated. In other words, the source is amplitude modulated before it is introduced to a fiber or conveyed to the photovoltaic converter at the optically switchable device. The amplitude modulation in this embodiment provides all three types of control information. This embodiment allows flexibility for controlling each of many downstream optically switchable devices independently. The control is more granular on a per device basis. However, as a trade-off, the device's local controller must be more sophisticated. Each controller might require a pulse width modulator, for example.

When the upstream controller provides control information to many different types of optically switchable devices, it must include address information with each of the distinct types of control information it sends downstream. This way, each of the devices recognizes whether the control information is intended for it, in which case it must pay attention to the information, or whether the control information is for a different device, in which case it can ignore the information.

Second embodiment-The light beam is modulated both by frequency and by amplitude. In some embodiments, the magnitude of the applied voltage is provided by frequency modulation and the polarity of the applied voltage and the remaining types of control information are provided by amplitude modulation. As an example, the signal is rectified by, e.g., a photovoltaic cell or the UDSU PPC or similar device, and the magnitude of the applied voltage is thereby encoded by the duty cycle of the frequency modulation applied upstream. The amplitude modulation is decoded by, e.g., an H-bridge located in the optically switchable device controller. This embodiment works well when all windows under control of the upstream driver have the same or similar drive voltage requirements. It has the benefit of scaling to a large number of devices controlled by a single upstream driver. A simple circuit on a small printed circuit board or single semiconductor device chip may be used. In one implementation, a PIC16LF1784 microcontroller from Microchip Technology of Chandler, AZ is used. The microcontroller may be used to decode AM information and determine polarity requirements. Further, an LV8019V H-bridge from ON Semiconductor of Santa Clara, CA may be used to implement the desired polarity. In such cases, the upstream circuitry responsible for encoding drive voltage magnitude is a pulse width modulator, a relatively expensive piece of equipment.

Various mechanisms for providing frequency modulation may be used. In one example, the light beam from a laser or solar collector is passed through a chopper that rotates at varying frequencies. In another example, a bar reciprocates in front of the light beam. One other embodiment involves frequency modulating the energy used to drive a laser.

Various mechanisms for providing amplitude modulation may be used. Examples include movable reflective and/or refractive elements that move angularly in front of the beam before delivery to optically switchable devices. Such devices are commonly controlled by piezoelectric mechanisms. In some cases, a graded optical density member is moved in front of the light beam. Such member may be controlled by, for example, a voice coil. Another embodiment involves amplitude modulating the energy used to drive a laser. Other examples include mechanisms for bending the fiber that conveys the light beam.

Third embodiment—In this embodiment, all types of control information are provided by frequency modulation. Typically, in this embodiment no amplitude modulation is applied to the source of photonic power. Thus, polarity, magnitude, and any other control information are encoded upstream by frequency modulation.

In summary, embodiments 2 and 3 shift much of the control logic upstream of the EC controller and IGU and allow relatively small, power efficient, and inexpensive controllers associated with the devices under control of a single upstream photonic driver. As a consequence, on board controllers for electrochromic devices such as the controllers described in U.S. Pat. No. 8,213,074 issued Jul. 3, 2012, which is herein incorporated by reference in its entirety, may be used.

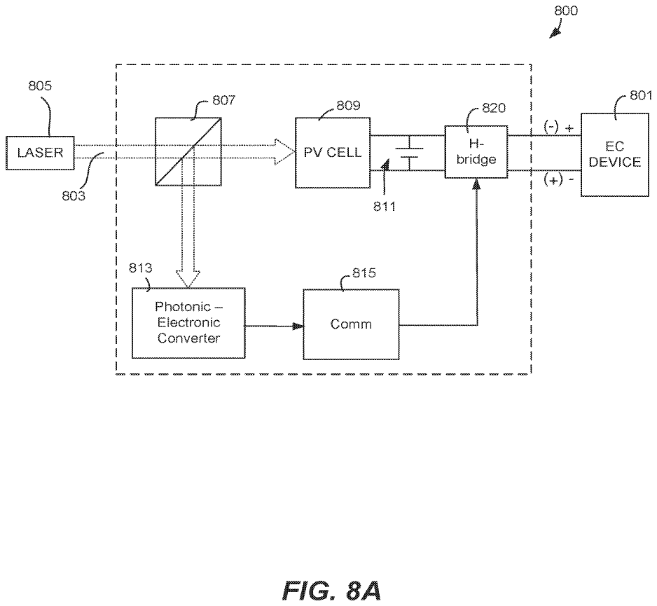

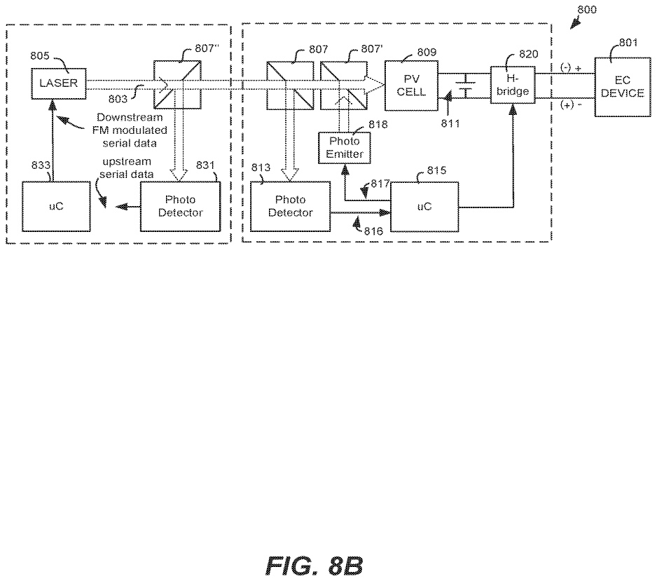

FIG. 8A depicts an embodiment of control hardware, 800, located near the optically switchable device 801, and, e.g., far from laser source 805. The hardware decodes control information encoded upstream in a light beam 803 from a laser 805, e.g., a laser diode. The light energy in the light beam 803 may be captured by a fiber optic cable or otherwise directed to a beam splitter 807, which directs a fraction of the beam energy for conversion to electricity, e.g., using a photovoltaic cell 809. Cell 809 converts the energy of beam 803 to electrical energy used to power optical transitions in a switchable device such as an optically switchable device and/or to charge a storage device 811. As mentioned, the photovoltaic cell may rectify FM signal in the light beam to provide drive voltage controlled by the FM encoding.

A driver (upstream and not shown) modulates laser diode 805 in a manner that encodes control information into light beam 803. In some implementations, a large fraction of the beam energy is directed by splitter 807 to the optically switchable device. For example, at least about 70% or at least about 90% of the beam energy may be directed to the photovoltaic cell. This energy is used to drive the device optical transitions.

A fraction of beam 803 is directed by splitter 807 to a photonic to electronic converter 813, which may be a photodiode for example. The converter 813 converts the beam energy to an electrical signal containing the encoded control information. The electrical output of converter 813 may be in direct current form. It is used to instruct a communications circuit 815 such as an H-bridge, 820. Regardless of how it is implemented, communications circuit 815 decodes the information in beam 803 to control, e.g., the polarity of voltage and/or current applied to the optically switchable device. As indicated above, AC encoding may be used to control the polarity.

In certain embodiments, energy obtained from the beam 803 is used to drive transitions in an optically switchable device by an amplifier such as a pulse width modulation amplifier. In other embodiments, the transitions are driven by a voltage regulator such as a Buck converter. The Buck converter may be used to produce/control the magnitude of the voltage applied to the EC device. An H-bridge device may be used to control the polarity of the voltage applied to the EC device.

Because optically switchable devices often require only small amounts of power to maintain an end optical state (e.g., tinted or clear), the local electrical circuits may be quite simple. This allows much of the instructions for driving transitions to be encoded upstream, away from the device. Therefore, the cost of the control logic at the device location is relatively low. In various embodiments, the electronics associated with each optically switchable device is modest.

In one particular embodiment, photonic energy is modulated upstream by frequency modulation (FM). In some implementations, the duty cycle of the FM signal is controlled upstream. Different duty cycles correspond to different voltage magnitudes. For example, a 90% duty cycle may correspond to 3V applied to the switchable device, while a 10% duty cycle may correspond to a 0.3V applied to the device. Thus, the duty cycle of the frequency modulated signal controls the magnitude of the applied voltage. In some embodiments, a pulse width modulation amplifier is employed to control the duty cycle and hence the magnitude of the voltage applied to the optically switchable device.

Additional control information may be provided by amplitude modulation (AM) imposed on the light beam from the photonic source. In some embodiments, the amplitude modulation is superimposed on an FM signal. In one example, the polarity of the voltage applied to the switchable device may be controlled by the AM signal. At the switchable device, simple H-bridge can be used to control the polarity using information conveyed via amplitude modulation.

In one embodiment, the optically switchable device controller is configured to transmit status information from the device upstream to an enhanced laser driver (with additional circuitry to decode this information). The upstream driver is optionally configured to relay the information to a BMS. The status information may include voltages and currents applied to the optically switchable device, the current transmission state (in transition from state to state, tinted to 4%, 20%, clear, etc.), operational status of the device controls (fault codes and diagnostics), environmental conditions such as ambient temperature, and the like.

FIG. 8B presents an example of a system configured to transmit device information upstream. Many of the features of the system are shared with the simpler implementation depicted in FIG. 8A. In this example, local microcontroller 815 receives input from one or more local sensors. Microcontroller 815 then converts the sensed data to instructions for driving a photoemitter 818 to generate a light beam encoded with the sensor data. Photoemitter 818 can be a laser diode, a photo diode, etc. In certain embodiments, photoemitter 818 emits light at a wavelength that is substantially removed from the wavelength of light from laser 805. In some implementations, the microcontroller converts the sensed data into a serial data stream (ones and zeros). As an example, the CANOpen protocol may be used. Using such protocol, microcontroller 815 encrypts the photonically transmitted data. The photoemitter simply turns on or off in response to the encrypted serial data stream from the microcontroller. A similar approach may be used to generate the downstream data.

In the embodiment depicted in FIG. 8B, photoemitter 818 directs emitted light to a second beam splitter 807′, which redirects the light upstream. In some embodiments, the emitted light is reflected from splitter 807′ back to the same optical transmission means that delivered the downstream light. For example, the splitter reflects the signal into a bidirectional optical fiber. The bi-directional transmission may be implemented in a manner similar to that employed in optical communications, usually by choosing different wavelength laser diodes. For example, the downstream transmission may be the high power amplitude modulated 850 nm laser, to deliver the necessary energy to drive the device transitions, and the upstream signal may be a 1310 nm diode laser. The beam splitters may be tuned for a wavelength (e.g., dichroic mirrors), or they may employ inserted filters, so that only the 1310 nm light reaches the upstream photodetector.

Upstream, an element receives and decodes the light emitted from photoemitter 818. In some designs, the upstream location employs an arrangement of components similar to that depicted in FIG. 8A. In the embodiment of FIG. 8B, a third beam splitter 807″ receives the upstream optical signal and reflects it to a photodetector 831, which outputs the unencoded data, in electrical form, to a microcontroller 833. Microcontroller 833 then decodes and otherwise processes the serial data stream. It may instruct the laser 805 based on the decoded data, or it may provide the decoded data to a master controller such as a BMS. In some cases, microcontroller 833 may be the same product employed in controller 815. Of course, the programming of these controllers may be specific for their roles in the system.

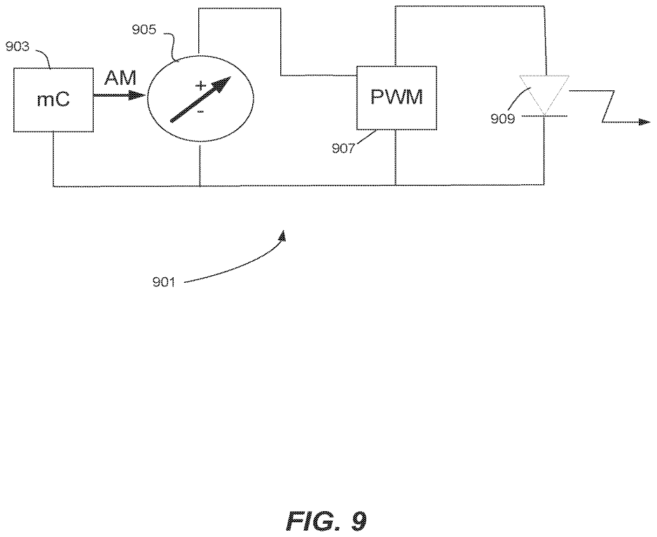

FIG. 9 depicts an example of a driver circuit 901 that applies FM and AM signals to a light beam. The AM signal is generated by a microcontroller 903 and applied to a voltage controlled voltage source (VCVS) 905, which applies the encoded polarity information to the light beam. The VCVS may be implemented with a voltage regulator such as the LM317 voltage regulator from Fairchild Semiconductor of San Jose, CA. Frequency modulation is applied via pulse width modulator (PWM) 907. The frequency and amplitude modulated signal is used to drive a diode laser 909. In some embodiments, the PWM is configured to apply varying duty cycle values to control the amplitude of the drive voltage/current applied to the switchable devices.

For periods of time when the sun is not shining and therefore not powering the laser diode or otherwise providing photonic energy for the optical transition, an alternative source of energy may be employed to power the transition. For example, the laser diode may be powered by electricity from the grid or a backup source in a building where the optically switchable devices reside. Alternatively, or in addition, the devices themselves may be powered by batteries or other storage devices located close to the windows, e.g., with the photovoltaic cells.

In certain embodiments, the photonic control information may be received from a building management system (BMS) or other high-level building controller for optically switchable devices. Examples of building level controllers and networks suitable for controlling all or many windows in a building are described in the following U.S. Patents and Patent Applications, each incorporated herein by reference in its entirety: U.S. patent application Ser. No. 13/049,756, filed Mar. 16, 2011, and titled “MULTIPURPOSE CONTROLLER FOR MULTISTATE WINDOWS”; U.S. patent application Ser. No. 13/449,235, filed Apr. 17, 2012, and titled “CONTROLLING TRANSITIONS IN OPTICALLY SWITCHABLE DEVICES”; U.S. patent application Ser. No. 13/772,969, filed Feb. 21, 2013, and titled “CONTROL METHOD FOR TINTABLE WINDOWS”; and U.S. Pat. No. 8,213,074, titled “ONBOARD CONTROLLER FOR MULTISTATE WINDOWS.”

In some embodiments, the photonic converter circuitry proximate the optically switchable device may be configured to receive remote control device signals that allow users in the locale of the device to turn the device off and on or otherwise control the device.

### Fiber Optic Sky Sensor Systems and Apparatus

Some sky sensors are multi-sensor systems that mount to the rooftop of a building where the sensors and other electrical components such as PoE connectors (data communication and power) might be exposed to external conditions such as rain and lighting. For example, one multi-sensor system had photosensors electrically connected to a printed circuit board (PCB) located inside a housing that mounted to a pole on the rooftop. The electrical components of this multi-sensor system were susceptible to damage from exposure to lightning, static electricity, rain, high humidity, bird droppings, etc. For example, under certain circumstances, this multi-sensor system might be damaged or destroyed by lightning strike and their electrical components shorted and corroded due to moisture intrusion.

Various implementations described herein pertain to fiber optic sky sensor systems with a fiber optic apparatus that is mounted or mountable to an exterior portion of a building and an indoor sensor apparatus inside the building. This fiber optic apparatus routes light collected from the external environment through fiber optic strands to the indoor sensor apparatus having sensors and other electrical components inside the building. Advantageously, these fiber optic sky sensor systems may lower the risk of lighting strike damage, moisture intrusion and other damage that might be caused by external environmental conditions since the sensors and other electrical components are protected inside the building.

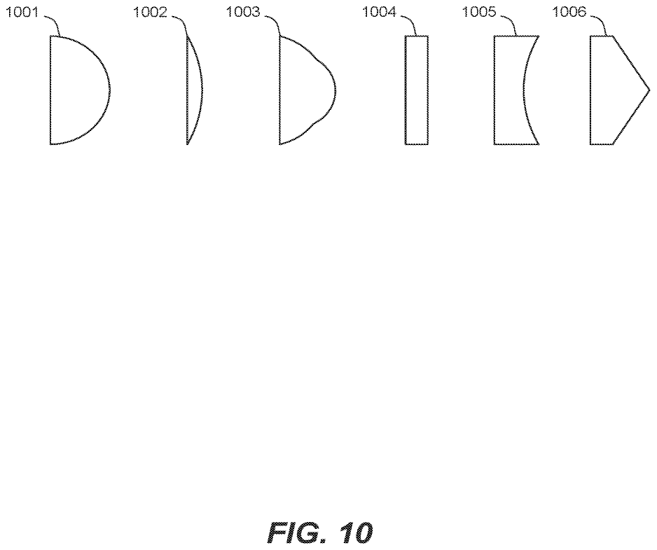

In certain examples, a fiber optic apparatus includes a housing that can be attached or mounted to an external structure on the rooftop or side of a building and fiber optic strands passing through at least a portion of the housing are positioned to receive light from the external environment at, e.g., different azimuthal and altitudinal angles. The fiber optic strands are in optical communication (e.g., via one or more other fiber optic strands coupled in series and/or one or more optical connectors) with one or more sensors e.g., photosensors and/or infrared sensors, inside the building. The sensors convert the light into signals that are sent to electronics, also within the building, to determine signal strength, digitize the signals, and communicate the digitized sensor data to a controller. In certain implementations, the fiber optic apparatus only includes non-electrically conductive material or a minimal amount of electrically conductive material to reduce the risk of lightning strike. Additionally, or alternatively, the fiber optic apparatus may have one or more electrically insulative coatings on one or more surfaces of its components. The housing of the fiber optic apparatus may include apertures or other light transmission regions in an external (outer) wall. In some cases, the external wall may be made of an opaque material or other light blocking material. Fiber optic strands may pass through at least a portion of the housing to the light transmissive regions to receive light from the external environment. In some implementations, the proximal ends of the fiber optic strands may be seated within or to the inside of the light transmissive regions. In other implementations, the proximal ends may extend outward from an external wall of the housing to the external environment. In some cases, the fiber optic strands are bare to receive light directly. In other cases, optical elements (e.g., collection lenses, light pipes such as optical waveguides, one or more filters, etc.) may be coupled to, or otherwise in optical communication with, the proximal ends of the fiber optic strands to collect the light from the external environment and pass and/or focus light delivered to the fiber optic strands. An example of an optical element that can be optically coupled to an end of a fiber optic strand is a collection lens. The fiber optic strand may be optically coupled to the collection lens via an optical coupler or the fiber optic strand may be fused directly to the collection lens. Another example of an optical elements that may be coupled to an end of an fiber optic strand is a lens with a light pipe. A commercially-available lens with a light pipe is the Lens cap, Light Pipe to Panel made by Industrial Fiber Optics in Tempe, Arizona. FIG. 10 is an illustration of cross-sections of different types of lenses 1001, 1002, 1003, 1004, 1005, and 1006 that may be used as collection lenses in a fiber optic apparatus, according to various implementations.

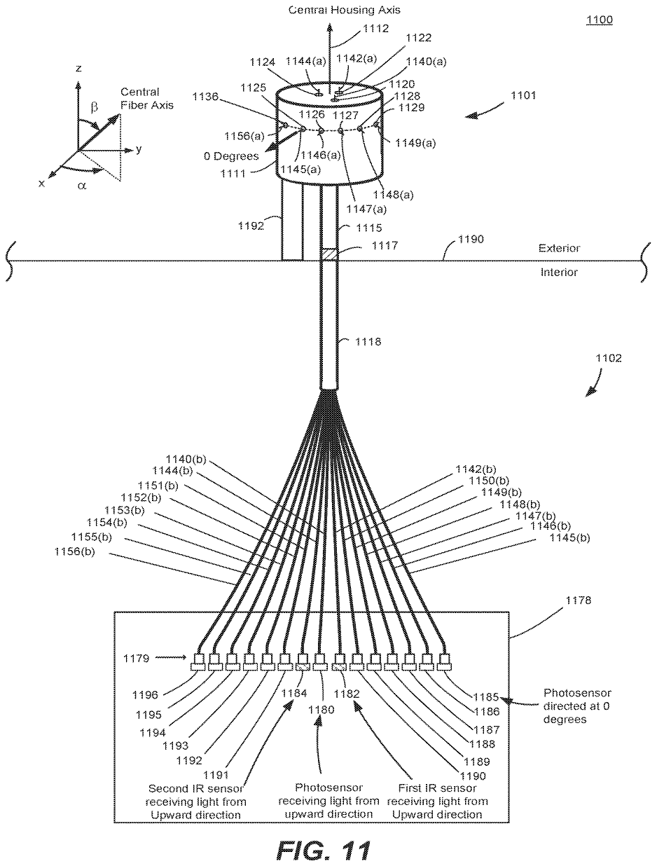

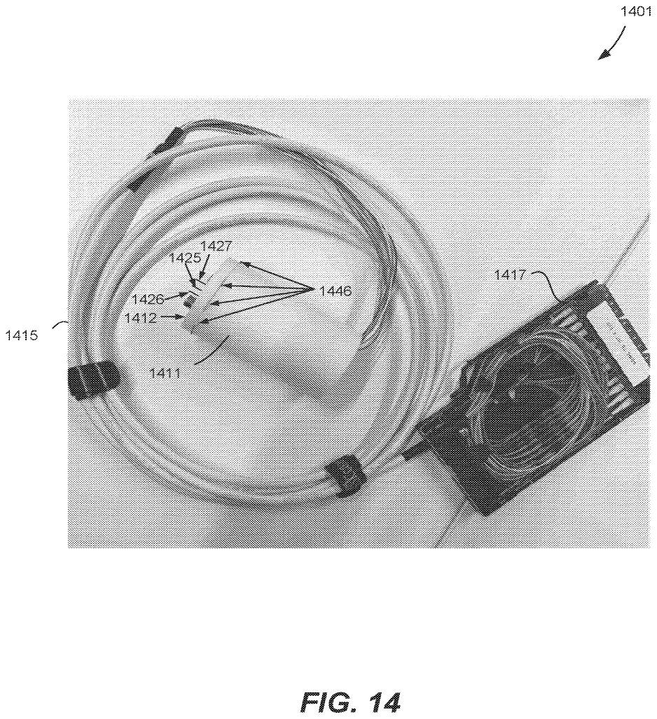

As mentioned above, the fiber optic apparatus of certain implementations may have proximal ends of fiber optic strands that are bare and extend through the external wall of the housing to the external environment. For example, in the illustration shown in FIG. 11, the fiber optic apparatus 1101 has fiber optic strands 1140(a), 1142(a), 1144(a), 1145(a), 1146(a), 1147(a), 1148(a), 1149(a), 1150(a), 1151(a), 1152(a), 1153(a), 1154(a), 1155(a) with proximal ends that are bare and pass through the external wall of a housing 1111 to the exterior environment to the exterior of a building 1190. As another example, the fiber optic apparatus 1401 in FIG. 14 includes fiber optic strands 1445 that are bare and pass through an external wall of a housing 1411.

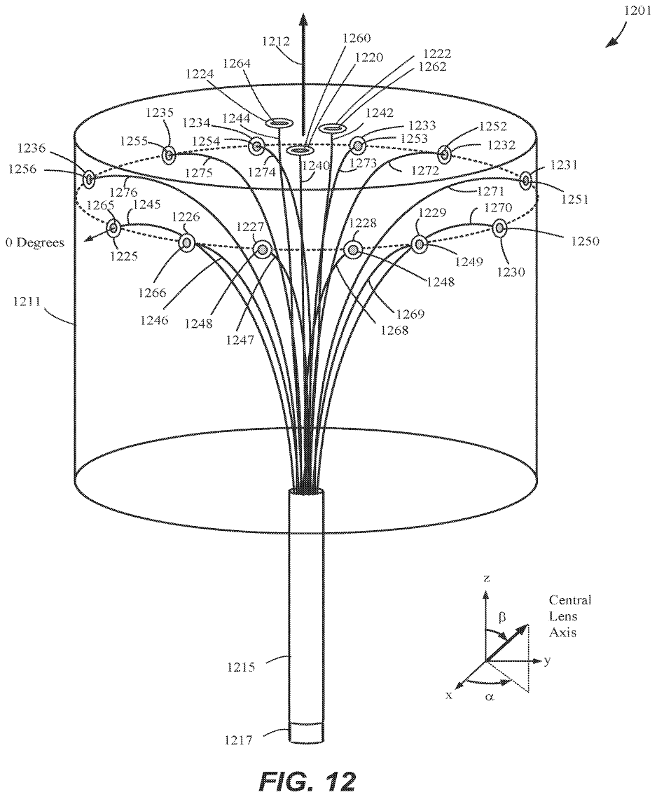

As also mentioned above, the fiber optic apparatus of certain implementations may have proximal ends of the fiber optic strands that are coupled to one or more optical elements (e.g., collection lenses, filters, etc.) to collect and/or focus light from the external environment and pass the light to the fiber optic strands. For example, in the illustrated example shown in FIG. 12, the fiber optic apparatus 1201 has fiber optic strands 1240, 1242, 1244, 1245, 1246, 1247, 1248, 1249, 1250, 1251, 1252, 1253, 1254, 1255 and 1256 with collection lenses 1260, 1262, 1264, 1265, 1266, 1267, 1268, 1269, 1270, 1271, 1272, 1273, 1274, 1275 and 1276 seated within apertures 1220, 1222, 1224, 1225, 1226, 1227, 1228, 1229, 1230, 1231, 1232, 1233, 1234, 1235 and 1236. In one implementation, a bandpass filter may lie in the optical path between the collection lens and the fiber optic strand. For example, a bandpass filter may be used that filters wavelength of 800 nm+/−10 nm.

In some cases, the apertures or light transmission regions in the outer wall of the housing may include one or more light transmissive materials. For example, the light transmission regions may include a light diffusing material and/or a bandpass filter material. In one example, one or more of the light transmission regions may include a material that can protect collection lenses seated within the apertures while passing light from the external environment. Additionally, or alternatively, the material protecting the collection lenses may include a bandpass filter material. A bandpass filter material may include, for example, a material that filters certain wavelength (e.g., wavelength of about 8 nm or wavelength in a range between 780 nm and 1 mm).

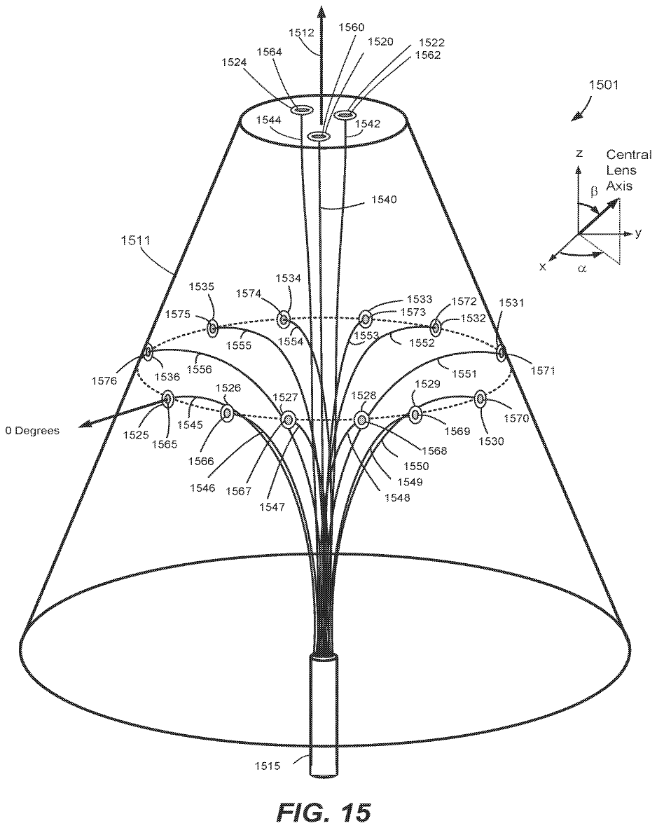

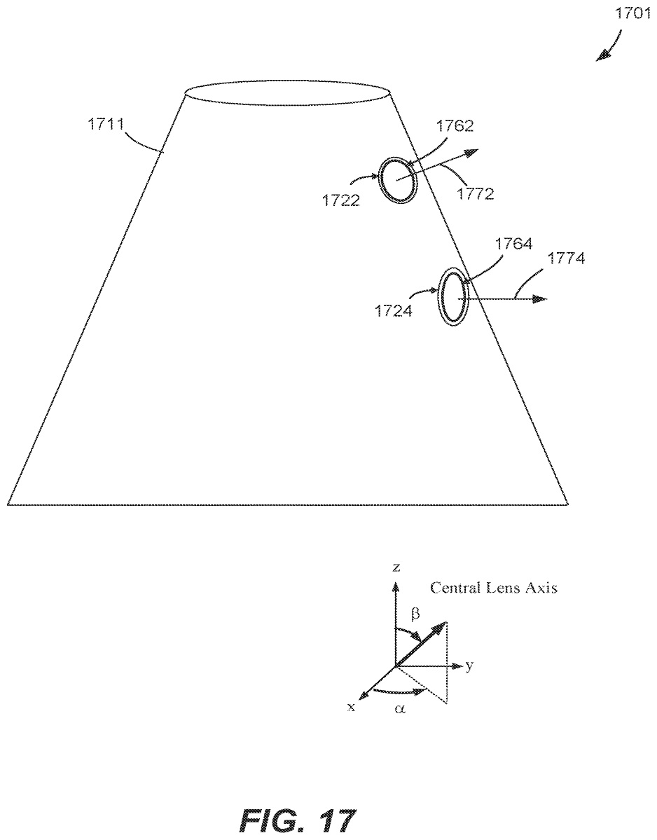

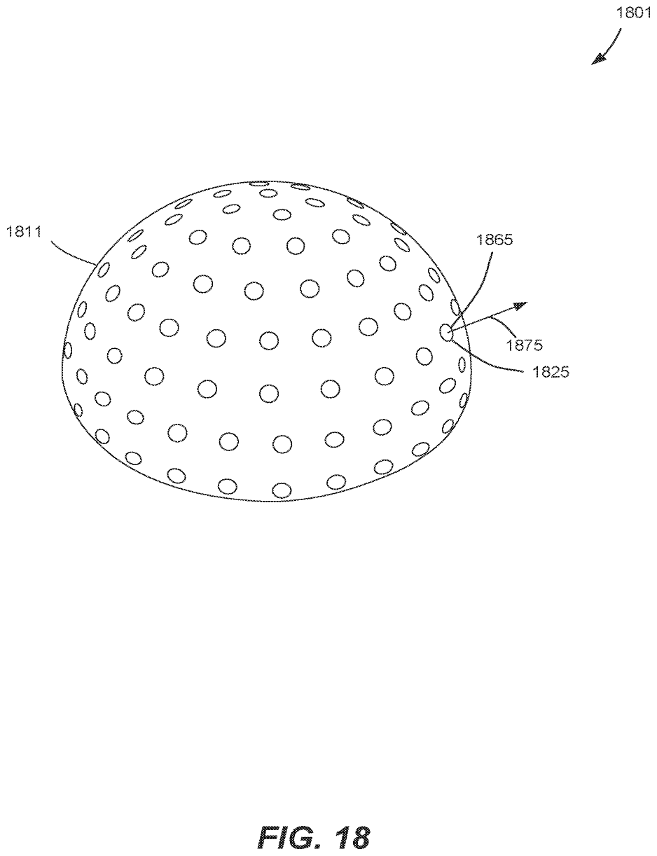

In certain implementations, at least a portion of the outer surface of the housing of a fiber optic apparatus may generally form a shape such as, for example, a cylinder, a hemisphere, a pyramid, a cube, a cuboid, a conical frustrum, a truncated sphere, a cross-section sphere, a four-prism, a hexagonal prism, or a pyramid, or a spherical segment. For example, the illustrated examples shown in FIGS. 15 and 17 have housings 1511 and 1711, respectively, with a conical frustrum shape. As another example, the illustrated implementation shown in FIG. 11 includes a housing 1111 with a cylindrical shape. In other examples, at least a portion of the outer surface of the housing may be in the form of a truncated sphere or a hemisphere with a constant curvature or that is multi-faceted. For instance, FIG. 18 illustrates a hemispherical housing 1811 with apertures 1825 distributed along an external surface having a constant curvature. In various examples, the optic fiber strands and/or collection lenses may be positioned at different sets of azimuthal and altitudinal angles.

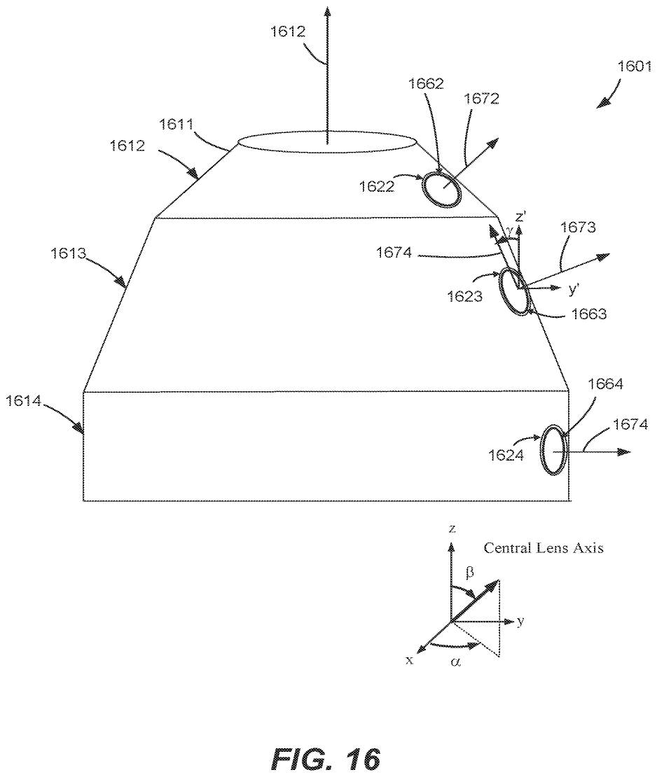

In other implementations, the housing of a fiber optic apparatus may have multiple portions of one or more shapes. For example, the illustrated example in FIG. 16 shows a housing 1611 with a first portion 1612 with a conical frustrum shape, a second portion 1613 with a conical frustrum shape, and a third portion 1614 with a cylindrical shape.

In some cases, at least a portion of the outer surface of a housing may have a constant curvature. In other cases, at least a portion of the outer surface may be multi-faceted.

In some implementations, the housing of a fiber optic apparatus may have one or more portions (e.g., an annular portion) that have outer surfaces with shapes that are radially symmetric or have circular symmetry about a central housing axis. For example, a housing may have a cylindrical portion or a hemispherical portion. In some cases, the shape of the housing may be designed to reduce the accumulation of substances such as snow, rain, ice, leaves, etc. from accumulating and/or to prevent birds from alighting on the fiber optic apparatus. For example, the housing may have a generally conical or conical frustrum shape (e.g., housing 1511 shown in FIG. 15) or at least an upper portion of the housing may have a conical shape to promote the shedding of snow or ice from the outer surface. As noted, in these examples, the optic fiber strands and/or collection lenses may be positioned at different sets of azimuthal and altitudinal angles at various positions on the housings.

The fiber optic strands and/or any collection lenses optically coupled to the fiber optic strands, each have a central axis with a direction that may correspond to a sun azimuthal angle and a sun altitudinal angle. For example, the fiber optic strands and/or collection lenses may be directed to collect light from different sets of sun azimuthal and altitudinal angles. The proximal ends of the bare fiber optic strands or the collection lenses receive photons within their field-of-view. For example, a collection lens may be oriented with its central lens axis directed to a particular azimuthal angle and altitudinal angle and collects photons within its field-of-view associated with its numerical aperture (NA). The collection lens may collect and transmit photons either directly, or via one or more additional optical elements, to the fiber optic strands. For example, a collection lens may be optically coupled to the fiber optic strand via a fiber optic coupler (also sometimes referred to herein as “optical connector”) or the fiber optic strand may be fused directly to the collection lens.

In some cases, the fields-of-views of adjacent fiber optic fibers and/or adjacent collection lenses may overlap. For example, the field-of-view of a collection lens may overlap with the field-of-view of one or more adjacent collection lenses. In one aspect, the field-of-view of one collection lens may overlap by 1% to 10% of a field-of-view of an adjacent collection lens.

In certain implementations, the housing includes a ring of apertures centered about a central housing axis and the fiber optic strands may be positioned within or extend through such apertures. For example, the fiber optic apparatus 1101 in FIG. 11 includes a ring of apertures 1125, 1126, 1127, 1128, 1129, 1130, 1131, 1132, 1133, 1134, 1135, and 1136. In some cases, the fiber optic apparatus also includes a ring of collection lenses also centered about the central housing axis. Each collection lens is optically coupled to a proximal end of a corresponding fiber optic strand and each collection lens is located within, or adjacent, to a corresponding aperture in the ring of apertures. For example, the fiber optic apparatus 1201 in FIG. 12 includes a ring of collection lenses 1265, 1266, 1267, 1268, 1269, 1270, 1271, 1272, 1273, 1274, 1275, and 1276 within respective apertures 1225, 1226, 1227, 1228, 1229, 1230, 1231, 1232, 1233, 1234, 1235, and 1236. The size and shape of the apertures and/or type of collection lenses in the rings may be generally the same according to one implementation.

In certain implementations, a plurality of fiber optic strands and/or collection lenses may be positioned in the housing with their central axes (central lens axis and/or central fiber axis) directed outward from the central housing axis at different sets of angles a, B (e.g., a=0, 30, 60, 90, 120, 150, 180, 210, 240, 270, 300, and 330 degrees and B=90 degrees).

During installation of the fiber optic apparatus at a building, the housing may be positioned to direct the fiber optic strands and/or collection lenses to align the angles a, B to particular sets of altitudinal and azimuthal angles, according to certain implementations. For example, a fiber optics apparatus may have a plurality of fiber optic strands and/or corresponding plurality of lenses with their central axes directed outward (β of about 90 degrees) and at different angles a around the central housing axis (α=0, 30, 60, 90, 120, 150, 180, 210, 240, 270, 300, and 330 degrees) around the central housing axis. For example, the fiber optic apparatus 1101 in FIG. 11 includes fiber optic strands 1145(a), 1146(a), 1147(a), 1148(a), 1149(a), 1150(a), 1151(a), 1152(a), 1153(a), 1154(a), 1155(a) and 1156(a) with their central axes directed outward from the central housing axis 1112 and at different sets of α, β angles where β is about 90 degrees and α=0, 30, 60, 90, 120, 150, 180, 210, 240, 270, 300, and 330 degrees. During installation, the fiber optic apparatus 1101 may be positioned such that the directions of the fiber optic strands are at α, β angles aligning to particular sets of sun altitudinal and azimuthal angles.

In one implementation, the fiber optic apparatus may be installed at the building such that the central housing axis is pointed in a direction approximately (e.g., +−5 degrees, +−1 degrees, +−2 degrees, +−3 degrees) opposite the direction of gravity so that the central lens/fiber axes are directed at an altitudinal angle of about 0 degrees. During this installation, the fiber optic apparatus may also be positioned so that the central lens/fiber axes are directed at azimuthal angles of 0 degrees (due North), 30, 60, 90, 120, 150, 180, 210, 240, 270, 300, and 330 degrees. For example, in the illustration shown in FIG. 12, the fiber optic apparatus 1201 includes a central housing axis 1212, a set of first collection lenses 1265, 1266, 1267, 1268, 1269, 1270, 1271, 1272, 1273, 1274, 1275, and 1276 that each have their central lens axis directed at angles α=0, 30, 60, 90, 120, 150, 180, 210, 240, 270, 300, and 330 degrees around the central housing axis 1212 and at a β of about 90 degrees, and a set of second collection lenses 1260, 1262, and 1264 with their central lens axes directed at a β of about 0 degrees. During installation, the fiber optic apparatus 1201 may be positioned such that the central housing axis 1212 is in a direction opposite the direction of gravity and the central lens axes are in directions aligned to different sets of azimuthal angles such as, e.g., azimuthal angles of 0, 30, 60, 90, 120, 150, 180, 210, 240, 270, 300, and 330 degrees where a 0 degrees azimuthal angle is due North, according to certain implementations. Positioning the fiber optic apparatus 1012 such that the central housing axis 1212 is in a direction opposite the direction of gravity directs the central lens axes of the set of second collection lenses 1260, 1262, and 1264 at a 90 degree altitudinal angle. In this example, the second collection lenses 1262 and 1264 are positioned during installation to face generally upward are in optical communication in one-to-one correspondence with infrared sensors inside the building, the second collection lens 1260 in optical communication with a photosensor inside the building, and the first collection lenses 1265, 1266, 1267, 1268, 1269, 1270, 1271, 1272, 1273, 1274, 1275, and 1276 are in optical communication in one-to-one correspondence with photosensors inside the building. The optical communication between the sensors and lenses may be through one or more sets of fiber optic strands and/or optical couplers, as provided herein.

In various implementations, the fiber optic apparatus may include a different number of apertures and/or lenses. In one example, the number of apertures is in a range of 12-200 apertures. In another example, a fiber optic apparatus includes 145 apertures distributed along the outer surface. For example, the fiber optic apparatus 1801 in FIG. 18 includes 145 apertures 1825 with a collection lens 1865 within each aperture. In this example, the collection lenses 1865 are positioned at installation to collect light at 145 different sets of azimuthal and altitudinal angles.

In certain implementations, a fiber optic strand is coupled at its proximal end to a light pipe or other optical element to transmit light collected by the light pipe to a distal end of the fiber optic strand. In some instances, the proximal end of the fiber optic strand collects light which is transmitted to the distal end of the strand. The distal end of the fiber optic strand may be coupled to an optical coupler or other optical element in optical communication with a corresponding sensor inside the building or the fiber optic strand may be coupled directly to the corresponding sensor inside the building. In some implementations, the fiber optic strands are capable of transmitting both visible and infrared wavelengths. An example of commercially available fiber optic coupler is 1×2 Multimode MMC Fiber Optic Coupler made by Fibertronics of Melbourne, Florida.

In certain implementations, a fiber optic sky sensor system includes a multifiber connector such as, e.g., a precision-aligned, low loss multifiber push-on or snap-on (MPO) connector, which connects one set of fiber optic strands to another set of fiber optic strands in one-to-one correspondence. For example, a fiber optic sky sensor system may include a multifiber connector to connect the distal ends of fiber optic strands passing out of the housing of the fiber optic apparatus to a second set of fiber optic strands that are in optical communication (via additional sets of fiber optic strands and/or optical couplers) with sensors inside the building. The multifiber connector may allow for ease of installation and removal of the fiber optic apparatus. Examples of multifiber connectors are multi-fiber connector 1217 in FIG. 12, multifiber connector 1417 described in FIG. 14, and multifiber connector 1117 described with respect to FIG. 11. An example of a commercially available MPO connector that includes two mating portions (male and female) for connection between a first set of twenty four (24) fiber optic strands and a second set of twenty four (24) fiber optic strands is the OM3 LC to 2 MTP Std made by Fibertronics of Melbourne, Florida. In some instances, the use of one or more fiber optic strands to connect a proximate end of one fiber optic strand (which may be connected to a light pipe or other optical element) with a sensor inside the building may be considered an optical pathway that spans between the proximate end of the one fiber optic strand and the sensor inside the building through the fiber optic strand segments. The optical pathway may be made of multiple fiber optic strands and one or more fiber or multifiber connectors.

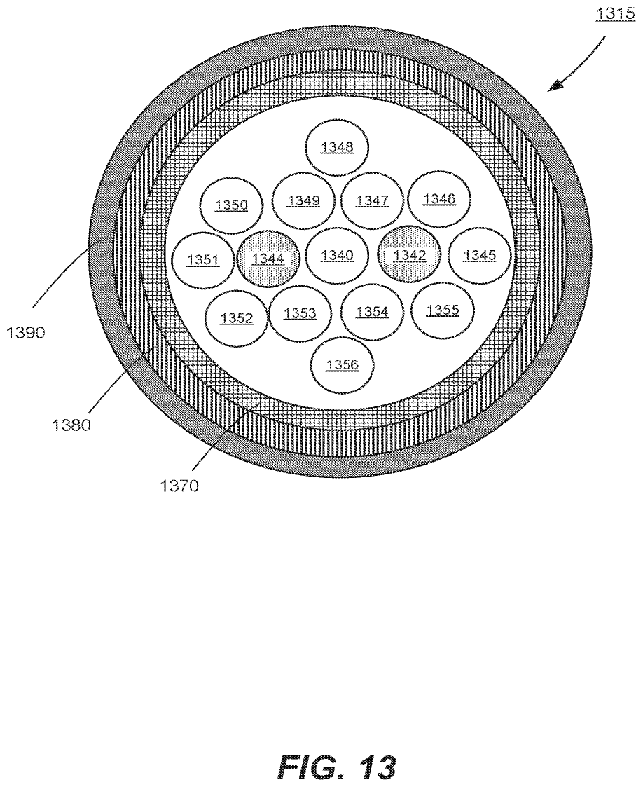

In some cases, a fiber optic sky sensor system includes one or more conduits (e.g., tubing) within which a bundle of fiber optic strands passes. For example, a fiber optic sky sensor system may include a conduit within which optic fiber strands pass between the housing of the fiber optic apparatus and the building. Examples of conduits include the conduits 1115 and 1118 in FIG. 11, conduit 1215 in FIG. 12, conduit 1315 in FIG. 13, and conduit 1415 in FIG. 14. The conduit typically includes one or more non-conductive material layers that protect and/or electrically insulate (e.g., a parylene coating). One or more of the material layers may include protective structures (e.g., fibers) such as aramid yarn, Kevlar fibers, etc. The fibers may be spiral, axial, radial, circumferential. Some examples of materials layers include a spiral armor layer, a Kevlar layer, a layer with aramid yarn, an electrically insulating layer, etc. An example of a commercially-available conduit is Aerial Fiber Optic Cable made by Hone. An example of a conduit with multiple material layers around the bundle of optic fiber strands is conduit 1315 in FIG. 13 with a first armor layer (e.g., a spiral armor layer) 1370, a second armor layer (e.g., a Kevlar layer) 1380 and an outer coating layer 1390 around a bundle of fiber optic strands 1240, 1242, 1244, 1245, 1246, 1247, 1248, 1249, 1250, 1251, 1252, 1253, 1254, 1255 and 1256. In one example, a conduit includes a spiral armor layer, a Kevlar layer, and an outer coating layer.

The indoor sensor apparatus includes a printed circuit board (PCB) with an electrical substrate having electronic components disposed thereon. The electronic components may include one or more sensors and other electronics capable of processing the sensor data. The fiber optic strands from the fiber optic apparatus may be in optical communication via other sets of fiber optic strands and/or optical couplers with the one or more sensors on the PCB. In some cases, the one or more sensors include one or more photosensors (e.g., complementary metal-oxide semiconductor (CMOS) sensors). In other cases, the one or more sensors include at least one photosensor and at least one infrared sensor. As noted herein, in some implementations the portion of the fiber optic sky sensor system that is exterior to the building does not contain electronics, sensors, PCBs, and/or other electrically conductive materials, and the portion inside the building does include such sensors, PCB, and other electronics of the fiber optic sky sensor system.

An infrared (IR) sensor can detect radiation in the infrared spectrum that is radiated from any object or medium within its field-of-view. In certain implementations, IR sensors generally have a field-of-view that ranges from about 50 to about 80 degrees. In one instance, an IR sensor has a field-of-view of about 70. The amount of IR radiation that is emitted by medium/objects and captured by the IR sensor varies depending on the temperature of the medium/objects, the surface and other physical characteristics of the medium/objects, and the distance from the IR sensor. The IR sensor converts IR radiation it receives within its field-of-view to an output voltage/current, which is a measurement of the amount of IR radiation received and the corresponding temperature of the objects/medium within its field-of-view. Typically, the IR sensor provides digital temperature readings. For example, an IR sensor oriented to face toward the sky (e.g., generally upward) outputs readings of temperature of the region of the sky within its field-of-view. Some examples of types of IR sensors that can be used are a thermopile, an infrared radiometer, an infrared pyrgometer, and an infrared pyrometer. Some examples of IR sensors that can be used include semiconductor resistors or diodes such as a long wave IR diode. One example of an IR sensor that can be used is the Melixis® IR sensor, which is a silicon-machined thermopile with digital temperature measurement output. Each IR sensor is typically devised to measure IR radiation within a specific wavelength range of the IR spectrum such as, in one case, in a range between about 8 μm and about 14 μm, in one case, in a range between about 10.6 μm and about 12.5 μm, in one case, in a range of about 6.6 μm and about 20 μm. In one example, an IR sensor is a thermistor bolometer responsive to infrared radiation in the wavelength range of 9.5 μm to 11.5 μm. In one example, the IR sensor is responsive to infrared radiation in the wavelength range of 8 μm to 14 μm. In one example, the IR sensor is responsive to infrared radiation in the wavelength range of 10.5 μm to 12.5 μm. In one example, the IR sensor is responsive to infrared radiation in the wavelength range of 6.6 μm to 20 μm.

In one implementation, the fiber optic sky sensor system can provide sensor readings that can be used to determine a weather condition. For example, the IR sensor readings can be used to determine a “clear sky” condition, a “cloudy” condition with intermittent clouds, or an “overcast” condition. Details of methods that use IR sensor readings to determine a weather condition are described in PCT application PCT/US15/53041, titled “SUNLIGHT INTENSITY OR CLOUD DETECTION WITH VARIABLE DISTANCE SENSING” and filed on Sep. 29, 2015, which is hereby incorporated by reference in its entirety.

In various implementations, sensor data obtained from light channeled from a fiber optic apparatus may be used to determine one or more tint states for an optically-switchable device (e.g., electrochromic device). In some implementations, the sensor data can be used for shadow modeling (e.g., tree or other building or structure position) or reflection modeling of the surrounding environment (such as from windows or other reflective surfaces in or on surrounding building or structures). In some implementations, the sensor data can be processed by a controller such as a master controller, network controller, or other controller. In some instances, the master controller may be located in the cloud or other external location. Such a controller can further analyze the sensor data, filter the sensor data and/or store the sensor data. In some implementations, the controller can provide a web server user interface (UI) to a user at a user computing device, for example, via a web socket (for example, HTML5), and in some instances, over an external facing data link. The web user interface (UI) can display the sensor data or processed sensor data for each and all of the sensors described above. The web UI also can display configuration and diagnostics (e, g., MAC address, IP address, Gateway address, Network mask, DNS, DHCP, Reboot, NTP, Event log, firmware version, firmware upgrade, etc.).

In some implementations, the fiber optic apparatus may include a removal device configured to at least partially remove or reduce accumulation of substances (e.g., water, ice, snow, hail, sleet, plant detritus such as leaves, dirt, sleet, animal excrement, etc.) on the housing that might obscure the light being received by the fiber optic strands. The removal device may include any number of elements. In one implementation, the removal device includes a heating element (e.g., a low wattage resistive heating element, a heating fluid flowing through tubes, a heating/cooling element such as a Peltier device, etc.) to melt accumulated snow or ice. A Peltier device refers to a solid-state active heat pump, which transfers heat, with consumption of electrical energy, depending on the direction of the current. When cooling is needed such as on a hot day, the Peltier device can be operated in the cooling mode to cool the inside of the housing. On a cold day, such as when snow or sleet might be present, the Peltier device can be operated in the heating mode to melt the snow or ice. A commercially-available Peltier device is the CP60233 made by Digi-Key Electronics of Thief River Falls, Minnesota. In another implementation, the removal device may include a flexible element that moves and/or inflates to dislodge ice, snow, and/or other substance that that may have accumulated on the housing. In yet another implementation, the removal device may include a manipulating device attached to the housing for rotating and/or translating the fiber optic apparatus. For instance, the fiber optic apparatus may include a telescoping arm coupled to the housing. In one case, the telescoping arm may be activated to telescope outward from the building when snow or ice has accumulated above a certain level and then retract as the level of snow/ice drops. The removal device may include one or more of the above described features.

FIG. 11 depicts a schematic diagram of a fiber optic sky sensor system 1100, according to implementations. Fiber optic sky sensor system 1100 includes a fiber optic apparatus 1101 located exterior to a building 1190 and an indoor sensor apparatus 1102 located interior to the building 1190. A mounting structure 1192 is attached to an exterior portion (e.g., roof or a side) of the building 1190. In this illustrated example, fiber optic apparatus 1101 is fixedly or removably coupled to mounting structure 1192. The mounting structure 1192 may be a wall, a pole, or other raised structure of the building. FIG. 11 also includes an x-axis, a y-axis, and a z-axis with an example a central fiber axis directed at an α angle and B angle. The z-axis may be parallel or substantially parallel to a central housing axis 1112.

Fiber optic apparatus 1101 includes a housing 1111 that is generally cylindrical in shape and rotationally symmetric about the central housing axis 1112 passing through the center of the housing 1111. In other implementations, the housing 1111 may have another shape as provided herein, such as a hemisphere, a pyramid, a cube, a cuboid, a conical frustrum, a truncated sphere, a cross-section sphere, a four-prism, a hexagonal prism, a pyramid, or a spherical segment. Optionally, housing 1111 may include a portion (e.g., an attachment mechanism) for fixedly or removably coupling to the mounting structure 1192.

According to one aspect, the mounting structure 1192 and/or the housing 1111 may include a removal device for preventing or at least partially removing accumulation of substances (e.g., rain, snow, ice, dirt, leaves, bird excrement, etc.) from the housing 1111. The removal device may include or more elements. In one implementation, the removal device may include a manipulating device for rotating or translating (e.g., raising and lowering) the fiber optic apparatus 1101. For example, the manipulating device may be a telescoping arm connected to the housing 1111 for raising and lowering fiber optic apparatus 1100. In another implementation, the removal device includes one or more movable components to dislodge a substance that may have accumulated on the housing 1111. For example, the removal device may include a flexible element that moves and/or inflates to dislodge ice, snow, and/or other substance that that may have accumulated. In another implementation, the removal device may include a heating element such as a resistive heating element or a heating fluid that is configured to flow through conduits through the housing to melt accumulated snow, ice, hail, etc.

Housing 1111 includes a ring of apertures 1125, 1126, 1127, 1128, 1129, 1130, 1131, 1132, 1133, 1134, 1135, and 1136 in an external wall of the cylindrical housing 1111. The apertures 1125, 1126, 1127, 1128, 1129, 1130, 1131, 1132, 1133, 1134, 1135, and 1136 are centered about central housing axis 1112 and distributed equidistantly along the circumference of the ring. Housing 1111 also includes a first aperture 1120, second aperture 1122, and a third aperture 1124 in an upper portion of the external wall of the housing 1111. In the illustrated example, fiber optic apparatus 1101 has been positioned, e.g., during installation, with its central housing axis 1112 oriented generally vertically upward (i.e., in a direction opposite the gravity vector or at 90 degrees altitudinal angle).

Fiber optic apparatus 1101 also includes a first set of fiber optic strands 1140(a), 1142(a), 1144(a), 1145(a), 1146(a), 1147(a), 1148(a), 1149(a), 1150(a), 1151(a), 1152(a), 1153(a), 1154(a), 1155(a) and 1156(a) that are at least partially positioned within an internal space of the housing 1111. In this example, the proximal ends of fiber optic strands 1140(a), 1142(a), 1144(a) pass through the apertures 1120, 1122, and 1124 in housing 1111 to the external environment and proximal ends of fiber optic strands 1145(a), 1146(a), 1147(a), 1148(a), 1149(a), 1150(a), 1151(a), 1152(a), 1153(a), 1154(a), 1155(a) and 1156(a) pass through the apertures 1126, 1127, 1128, 1129, 1130, 1131, 1132, 1133, 1134, 1135, and 1136 in housing 1111 to the external environment. In this implementation, the proximal ends of fiber optic strands 1140(a), 1142(a), 1144(a), 1145(a), 1146(a), 1147(a), 1148(a), 1149(a), 1150(a), 1151(a), 1152(a), 1153(a), 1154(a), 1155(a) and 1156(a) are bare and receive light directly from the external environment. In another implementation, the fiber optic strands 1140(a), 1142(a), 1144(a), 1145(a), 1146(a), 1147(a), 1148(a), 1149(a), 1150(a), 1151(a), 1152(a), 1153(a), 1154(a), 1155(a) and 1156(a) may be located within, or to the inside of, apertures and further optionally, the housing 1111 may include collection lenses or one or more other optical elements (e.g., seated within the apertures) where each collection lens is coupled via an optical coupler or fused directly to a corresponding fiber optic strand. Fiber optic strands 1145(a), 1146(a), 1147(a), 1148(a), 1149(a), 1150(a), 1151(a), 1152(a), 1153(a), 1154(a), 1155(a) and 1156(a) have central fiber axes directed at α=0, 30, 60, 90, 120, 150, 180, 210, 240, 270, 300, and 330 degrees respectively and at β=90 degrees.

During installation, the fiber optic apparatus 1101 may be positioned to align the central fiber axes to a set of azimuthal angles such as, e.g., azimuthal angles of 0 (due North), 30, 60, 90, 120, 150, 180, 210, 240, 270, 300, and 330 degrees respectively and at approximately 0 degrees altitudinal angle (e.g., +−2 degrees). The azimuthal angle refers to the angle formed between a vector directed due North and a line at 0 degrees elevation angle. Fiber optic strands 1140(a), 1142(a), and 1144(a) have central fiber axes directed at B=0 degrees which may be aligned during installation to be directed generally vertically upward i.e., in a direction opposite the gravity vector or at 90 degrees altitudinal angle.

Fiber optic sky sensor system 1100 also includes a first conduit 1115 within which the fiber optic strands 1140(a), 1142(a), 1144(a), 1145(a), 1146(a), 1147(a), 1148(a), 1149(a), 1150(a), 1151(a), 1152(a), 1153(a), 1154(a), 1155(a) and 1156(a) may pass from the housing 1111 to, e.g., the building 1190. The first conduit 1115 may be made of at least one electrically insulative material. In some embodiments, the first conduit 1115 may also be a support structure. For example, the optical sky sensor system 1110 may include a hollow cylindrical pole that is both a conduit for the fiber optic strands and a support structure for fiber optic apparatus 110 such that the housing is coupled to one end of the pole. In this example, the fiber optic strands 1140(a), 1142(a), 1144(a), 1145(a), 1146(a), 1147(a), 1148(a), 1149(a), 1150(a), 1151(a), 1152(a), 1153(a), 1154(a), 1155(a) and 1156(a) may pass through the housing 1111 and the hollow cylindrical pole to a multi-fiber connector or into the interior of the building and the indoor sensor apparatus 1102. This is discussed further below with respect to FIG. 12, for example.

In certain implementations, the fiber optic strands with proximal ends in the housing of the fiber optic apparatus may be in optical communication (e.g., via optical couplers) with one or more additional sets of fiber optic strands in series to provide optical communication between the fiber optic strands passing through the housing and the sensors in the indoor sensor apparatus. In FIG. 11, for example, fiber optic sky sensor system 1100 includes an indoor sensor apparatus 1102 with a second set of fiber optic strands 1140(b), 1142(b), 1144(b), 1145(b), 1146(b), 1147(b), 1148(b), 1149(b), 1150(b), 1151(b), 1152(b), 1153(b), 1154(b), 1155(b) and 1156(b). Fiber optic sky sensor system 1100 also includes a multi-fiber connector (MPO) 1117 that optically couples the distal ends of the (first) set of fiber optic strands 1140(a), 1142(a), 1144(a), 1145(a), 1146(a), 1147(a), 1148(a), 1149(a), 1150(a), 1151(a), 1152(a), 1153(a), 1154(a), 1155(a) and 1156(a) with proximal ends of another (second) set of fiber optic strands 1140(b), 1142(b), 1144(b), 1145(b), 1146(b), 1147(b), 1148(b), 1149(b), 1150(b), 1151(b), 1152(b), 1153(b), 1154(b), 1155(b) and 1156(b). Although two sets are illustrated, there may be more than two sets of fiber optic strands that are connected together according to other implementations.

Indoor sensor apparatus 1102 also includes a second conduit 1118 within which the second set of fiber optic strands 1140(b), 1142(b), 1144(b), 1145(b), 1146(b), 1147(b), 1148(b), 1149(b), 1150(b), 1151(b), 1152(b), 1153(b), 1154(b), 1155(b) and 1156(b) pass in the interior of the building 1190. Indoor sensor apparatus 1102 also includes a printed circuit board (PCB) 1178 with a plurality of sensors 1180, 1182, 1184, 1185, 1186, 1187, 1188, 1189, 1190, 1191, 1192, 1193, 1194, 1195, and 1196 on an electrical substrate of the PCB 1178. The plurality of sensors includes a first infrared sensor 1182 and a second infrared sensor 1184 in optical communication with fiber optic strands 1142 and 1144 having proximal ends that are pointed generally upward. The plurality of sensors also includes a photosensor 1180 in optical communication with fiber optic strand 1140 with a proximal end that is also pointed generally upward. The plurality of sensors also includes a plurality of photosensors 1185, 1186, 1187, 1188, 1189, 1190, 1191, 1192, 1193, 1194, 1195, and 1196 that are in optical communication with fiber optic strands 1145(a), 1146(a), 1147(a), 1148(a), 1149(a), 1150(a), 1151(a), 1152(a), 1153(a), 1154(a), 1155(a) and 1156(a) with proximal ends directed at α=0, 30, 60, 90, 120, 150, 180, 210, 240, 270, 300, and 330 degrees respectively which may be aligned during installation with a set of azimuthal angles such as, e.g., azimuthal angles of 0 (due North), 30, 60, 90, 120, 150, 180, 210, 240, 270, 300, and 330 degrees respectively. The sensors 1180, 1182, 1184, 1185, 1186, 1187, 1188, 1189, 1190, 1191, 1192, 1193, 1194, 1195, and 1196 are optically coupled to fiber optic strands 1140(b), 1142(b), 1144(b), 1145(b), 1146(b), 1147(b), 1148(b), 1149(b), 1150(b), 1151(b), 1152(b), 1153(b), 1154(b), 1155(b) and 1156(b) via optical couplers 1179. An example of an optical coupler that can be employed is an RJ-45 fiber optic connector. An optical coupler or connector may include a push-pull mechanism for secure, sealed interconnection in which all common fiber optic strands can be terminated.

In some implementations, the sensors on a PCB of a fiber optic sky sensor system may be calibrated, for example, on a periodic basis (e.g., daily, weekly, monthly, etc.) or in response to instructions from a controller. For example, circuitry on PCB 1178 in FIG. 11 may be configured to automatedly calibrate photosensors 1180, 1185, 1186, 1187, 1188, 1189, 1190, 1191, 1192, 1193, 1194, 1195, and 1196 and infrared sensors 1182 and 1184. In some cases, calibrating the photosensors may include adjusting the offset voltages of the photosensors to adjust the gain of photosensors or adjust the dynamic range of the photosensors. Calibration data may be stored in memory in the circuitry on the PCB and may be applied by one or more microcontrollers.

Although fiber optic sky sensor system 1100 in FIG. 11 includes a fiber optic apparatus 1101 with a cylindrical shaped housing 1111 with first set of fiber optic strands 1140(a), 1142(a), 1144(a), 1145(a), 1146(a), 1147(a), 1148(a), 1149(a), 1150(a), 1151(a), 1152(a), 1153(a), 1154(a), 1155(a) and 1156(a) in certain directions, according to other implementations, different shapes of housing can be used. In addition or alternatively, the first set of fiber optic strands may be in different directions and/or a set of lenses may be optically coupled to respective fiber optic strands.

FIG. 12 depicts a schematic diagram of a fiber optic apparatus 1201 that can be mounted or coupled to an exterior portion (e.g., roof or side) of a building. Fiber optic apparatus 1201 includes a housing 1211 with a generally cylindrical shape that is rotationally symmetric about a central housing axis 1212 passing through the center of the housing 1211. Optionally, housing 1211 may include an attachment mechanism for fixedly or removably coupling housing 1211 to an exterior portion of the building. Optionally, the housing 1211 may include a removal device for preventing or at least partially removing accumulation of substances on housing 1211. FIG. 12 also includes an x-axis, a y-axis, and a z-axis with an example a central lens axis directed at an a angle and Bangle. The z-axis may be parallel or substantially parallel to the central housing axis 1212.

Housing 1211 includes a ring of apertures 1225, 1226, 1227, 1228, 1229, 1230, 1231, 1232, 1233, 1234, 1235, and 1236 in an external wall of the cylindrical housing 1211. The apertures 1225, 1226, 1227, 1228, 1229, 1230, 1231, 1232, 1233, 1234, 1235, and 1236 are centered about a central housing axis 1212 and distributed equidistantly along the circumference of the ring. Housing 1211 also includes a first aperture 1220, a second aperture 1222, and a third aperture 1224 in an upper portion of the external wall of the housing 1211.

Fiber optic apparatus 1201 also includes lenses 1260, 1262, 1264, 1265, 1266, 1267, 1268, 1269, 1270, 1271, 1272, 1273, 1274, 1275 and 1276 seated within apertures 1225, 1226, 1227, 1228, 1229, 1230, 1231, 1232, 1233, 1234, 1235, and 1236 and a set of fiber optic strands 1240, 1242, 1244, 1245, 1246, 1247, 1248, 1249, 1250, 1251, 1252, 1253, 1254, 1255 and 1256 that are at least partially positioned within an internal space (volume) of the housing 1211.

The set of fiber optic strands 1240, 1242, 1244, 1245, 1246, 1247, 1248, 1249, 1250, 1251, 1252, 1253, 1254, 1255 and 1256 are coupled to (e.g., via an optical coupler or fused directly to) respective lenses 1260, 1262, 1264, 1265, 1266, 1267, 1268, 1269, 1270, 1271, 1272, 1273, 1274, 1275 and 1276. Lenses 1265, 1266, 1267, 1268, 1269, 1270, 1271, 1272, 1273, 1274, 1275 and 1276 have their central lens axes directed at α=0, 30, 60, 90, 120, 150, 180, 210, 240, 270, 300, and 330 degrees respectively and at β=90 degrees. During installation, the fiber optic apparatus 1101 may be positioned to align the central fiber axes to a set of azimuthal angles such as azimuthal angles of 0 (due North), 30, 60, 90, 120, 150, 180, 210, 240, 270, 300, and 330 degrees respectively and at approximately 0 degrees altitudinal angle (e.g., +−2 degrees). Lenses 1260, 1262, are 1264 have their central lens axes directed at β=0 degrees which may be aligned during installation to be directed generally vertically upward direction i.e., in a direction opposite the gravity vector or at 90 degrees altitudinal angle.

Fiber optic strands 1242 and 1244 that receive light from lenses 1262 and 1264 are directed generally vertically upward and may be in optical communication with infrared sensors configured to take measurements of infrared light and generate infrared readings. Fiber optic strand 1240 that receives light from lens 1260 is directed generally vertically upward and may be in optical communication with a photosensor to take measurements of visible light received to generate photosensor readings (e.g., irradiance readings). Fiber optic strands 1245, 1246, 1247, 1248, 1249, 1250, 1251, 1252, 1253, 1254, 1255 and 1256 that receive light from lenses 1265, 1266, 1267, 1268, 1269, 1270, 1271, 1272, 1273, 1274, 1275 and 1276 with central lens axes at α=0, 30, 60, 90, 120, 150, 180, 210, 240, 270, 300, and 330 degrees respectively, which may be aligned during installation to a set of azimuthal angles such as azimuthal angles of 0 (due North), 30, 60, 90, 120, 150, 180, 210, 240, 270, 300, and 330 degrees, are in optical communication with photosensors to take measurements of visible light to generate photosensor readings (e.g., irradiance readings).

Fiber optic apparatus 1201 also includes a conduit 1215 within which the fiber optic strands 1240, 1242, 1244, 1245, 1246, 1247, 1248, 1249, 1250, 1251, 1252, 1253, 1254, 1255 and 1256 may pass from the housing 1211 to a multi-fiber connector 1217. The multi-fiber connector 1217 may connect the fiber optic strands 1240, 1242, 1244, 1245, 1246, 1247, 1248, 1249, 1250, 1251, 1252, 1253, 1254, 1255 and 1256 to another set of fiber optic strands optically coupled to a plurality of sensors.

FIG. 13 is a cross-sectional drawing depicting an example of a conduit 1315 of a fiber optic apparatus, according to various implementations. Conduit 1315 may be an example of the conduit 1215 of fiber optic apparatus 1200 in FIG. 12. Conduit 1315 includes a first armor layer (e.g., a spiral armor layer) 1370, a second armor layer (e.g., a Kevlar layer) 1380, and an outer coating layer 1390 around a bundle of tubing having fiber optic strands 1340, 1342, 1344, 1345, 1346, 1347, 1348, 1349, 1350, 1351, 1352, 1353, 1354, 1355 and 1356. Fiber optic strands 1342 and 1344 may be in optical communication with infrared sensors and fiber optic strands 1340, 1345, 1346, 1347, 1348, 1349, 1350, 1351, 1352, 1353, 1354, 1355 and 1356 may be in optical communication with photosensors.

FIG. 14 depicts a photograph of a fiber optic apparatus 1401 including a housing 1411 with a generally cylindrical shape, a conduit 1415, and a multi-fiber connector 1417, according to an implementation. Housing 1411 is generally rotationally symmetric about a central housing axis (e.g., 1212 in FIG. 12) passing through the center of the housing 1411. Housing 1411 can be mounted or coupled to an exterior portion (e.g., roof or side) of a building. Optionally, housing 1411 may include an attachment mechanism for fixedly or removably coupling housing 1411 to the building.

Fiber optic apparatus 1401 also includes fiber optic strands that are at least partially positioned within an internal space of the housing 1411. The proximal ends of a first set of three fiber optic strands including a first fiber optic strand 1425, a second fiber optic strand 1426, and third fiber optic strand 1427 that pass through an upper portion 1412 of the housing 1411. During installation, the fiber optic apparatus 1402 may be positioned to direct the central housing axis in a direction opposite the gravity vector or at 90 degrees altitudinal angle. The first fiber optic strand 1425 is in optical communication with a photosensor. The second and third fiber optic strands 1426 and 1427 may be in optical communication with two infrared sensors respectively. The proximal ends of a second set of fiber optic strands 1446 pass through a side wall of the housing 1411 and are positioned to direct their central fiber axes at their proximal ends at α=0, 30, 60, 90, 120, 150, 180, 210, 240, 270, 300, and 330 degrees respectively and at β=90 degrees. During installation, the fiber optic apparatus 1401 may be positioned to align the central fiber axes to a set of azimuthal angles such as, e.g., azimuthal angles of 0 (due North), 30, 60, 90, 120, 150, 180, 210, 240, 270, 300, and 330 degrees. The second set of fiber optic strands 1446 may be in optical communication with photosensors.

Fiber optic apparatus 1401 also includes a conduit 1415 within which the first set of fiber optic strands 1425, 1426, and 1427 and the second set of fiber optic strands 1446 pass from the housing 1411 to a multi-fiber connector 1417. An example of a commercially-available multi-fiber connector is the RJ45 Industrial Fiber Optic Connector made by Mouser electronics of Mansfield Texas. In certain implementations, a multi-fiber connector may include a hard shell that withstands harsh environments such as shock, vibration, and extreme temperatures. In some cases, a multi-fiber connector includes a push-pull mechanism or snap mechanism configured to seat and secure connection with fiber optic strands terminated at the multi-fiber connector.

FIG. 15 depicts a schematic diagram of a fiber optic apparatus 1501 that can be mounted or coupled to an exterior portion (e.g., roof or side) of a building. Fiber optic apparatus 1501 includes a housing 1511 with a generally conical frustrum shape that is rotationally symmetric about a central housing axis 1512 passing through the center of the housing 1511. Optionally, housing 1511 may include an attachment mechanism for fixedly or removably coupling housing 1511 to an exterior portion of the building. Optionally, the housing 1511 may include a removal device for preventing or at least partially removing accumulation of substances on housing 1511. FIG. 15 also includes an x-axis, a y-axis, and a z-axis with an example a central lens axis directed at an α angle and a B angle.

Housing 1511 includes a ring of apertures 1525, 1526, 1527, 1528, 1529, 1530, 1531, 1532, 1533, 1534, 1535, and 1536 in an external wall of the cylindrical housing 1511. The apertures 1525, 1526, 1527, 1528, 1529, 1530, 1531, 1532, 1533, 1534, 1535, and 1536 are centered about central housing axis 1512 and distributed equidistantly along the circumference of the ring. Housing 1511 also includes a first aperture 1520, second aperture 1522, and a third aperture 1524 in an upper portion of the external wall of the housing 1511.

Fiber optic apparatus 1501 also includes lenses 1560, 1562, 1564, 1565, 1566, 1567, 1568, 1569, 1570, 1571, 1572, 1573, 1574, 1575 and 1576 seated within apertures 1525, 1526, 1527, 1528, 1529, 1530, 1531, 1532, 1533, 1534, 1535, and 1536 and a set of fiber optic strands 1540, 1542, 1544, 1545, 1546, 1547, 1548, 1549, 1550, 1551, 1552, 1553, 1554, 1555 and 1556 that are at least partially positioned within an internal space of the housing 1511. The set of fiber optic strands 1540, 1542, 1544, 1545, 1546, 1547, 1548, 1549, 1550, 1551, 1552, 1553, 1554, 1555 and 1556 are coupled to (e.g., via an optical coupler or fused directly to) respective lenses 1560, 1562, 1564, 1565, 1566, 1567, 1568, 1569, 1570, 1571, 1572, 1573, 1574, 1575 and 1576. Lenses 1565, 1566, 1567, 1568, 1569, 1570, 1571, 1572, 1573, 1574, 1575 and 1576 are directed at α=0, 30, 60, 90, 120, 150, 180, 210, 240, 270, 300, and 330 degrees respectively and at β=90 degrees. During installation, the fiber optic apparatus 1501 may be positioned to align the central lens axes to a set of azimuthal angles such as, e.g., azimuthal angles of 0 (due North), 30, 60, 90, 120, 150, 180, 210, 240, 270, 300, and 330 degrees respectively and at approximately 0 degrees altitudinal angle (e.g., +−2 degrees). This orientation of the lenses thereby may cause the lenses to be oriented at a different angle than that of the exterior surface of the conical frustrum shape of the housing 1511. Lenses 1560, 1562, are 1564 have central fiber axes directed at β=90 degrees which may be aligned during installation to be directed in a generally vertically upward direction i.e., in a direction opposite the gravity vector or at 90 degrees altitudinal angle.

Fiber optic strands 1542 and 1544 that receive light from lenses 1562 and 1564 directed generally vertically upward may be in optical communication with infrared sensors to take infrared readings. Fiber optic strand 1540 that receives light from lens 1560 directed generally vertically upward may be in optical communication with a photosensor to take readings of visible light (e.g., irradiance readings). Fiber optic strands 1545, 1546, 1547, 1548, 1549, 1550, 1551, 1552, 1553, 1554, 1555 and 1556 that receive light from lenses 1565, 1566, 1567, 1568, 1569, 1570, 1571, 1572, 1573, 1574, 1575 and 1576 may have directions aligned to azimuthal angles of 0 (due North), 30, 60, 90, 120, 150, 180, 210, 240, 270, 300, and 330 degrees during installation. ). Fiber optic strands 1545, 1546, 1547, 1548, 1549, 1550, 1551, 1552, 1553, 1554, 1555 and 1556 may be in optical communication with photosensors to take measurements of visible light and generate photosensor readings (e.g., irradiance readings).

Fiber optic apparatus 1501 also includes a conduit 1515 within which the fiber optic strands 1540, 1542, 1544, 1545, 1546, 1547, 1548, 1549, 1550, 1551, 1552, 1553, 1554, 1555 and 1556 may pass from the housing 1511 to the multi-fiber connector 1517.

In some implementations, the housing of a fiber optic apparatus may have different portions (sections) and each of the lenses is positioned to direct its central lens axis in a direction perpendicular to a line/direction along the surface of the sections, e.g., the apertures and/or lenses are oriented normal to the angle of the surface on which they are positioned.

FIG. 16 depicts a schematic diagram of a fiber optic apparatus 1601 that can be mounted or coupled to an exterior portion (e.g., roof or side) of a building. Fiber optic apparatus 1601 includes a housing 1611 with a first portion 1612 having a conical frustrum shape, a second portion 1613 having a conical frustrum shape, and a third portion 1614 having a cylindrical shape. In other implementations, other shapes may be used. FIG. 16 also includes an x-axis, a y-axis, and a z-axis with an example a central lens axis directed at an α angle and a B angle.

Housing 1611 includes a first aperture 1622 in a side wall of first portion 1612, a second aperture 1623 in a side wall of second portion 1613, and a third aperture 1624 in a side wall of third portion 1614. Housing 1611 also includes a first lens 1662, a second lens 1663, and a third lens 1664. First lens 1662 is seated within the first aperture 1622 and is positioned with its central lens axis 1672 directed at a first a angle and a first B angle. Second lens 1663 is seated within second aperture 1623 and is positioned with its central lens axis 1673 directed at a second a angle and a second B angle. Third lens 1664 is seated within third aperture 1624 and is positioned with its central lens axis 1674 directed at a third α angle and a second B angle of approximately 90 degrees (e.g., in a range of 90 degrees +−1 degree). In some implementations, as illustrated in FIG. 16, the apertures and/or lenses are oriented at a direction along the conical frustum surface in which they are positioned. For example, the second lens 1663 is seated within the first aperture 1623 and is oriented in a direction 1674 along the conical frustum surface which is at an angle, γ, with respect to a local z′ axis (parallel to the central housing axis 1612). The second lens 1663 is positioned such that its central lens axis 1673 is perpendicular to the direction 1674 formed along the conical frustum surface.

A different fiber optic strand is optically coupled to each of the lenses, 1662, 1663, and 1664. A first fiber optic strand optically coupled to first lens 1662 may be in optical communication with an infrared sensor. A fiber optic strand optically coupled to second lens 1663 may be in optical communication with a first photosensor. A fiber optic strand optically coupled to third lens 1664 may be in optical communication with a second photosensor.

In some implementations, the lenses of a fiber optic apparatus are positioned to direct their central lens axes in directions that are different from directions perpendicular to the surface of the housing. FIG. 17 depicts a schematic diagram of a fiber optic apparatus 1701 that can be mounted or coupled to an exterior portion (e.g., roof or side) of a building. Fiber optic apparatus 1701 includes a housing 1711 having a conical frustrum shape. FIG. 17 also includes an x-axis, a y-axis, and a z-axis with an example a central lens axis directed at an a angle and a B angle.

Housing 1711 includes a first aperture 1722 and a second aperture 1724 in a side wall of the housing 1711. Housing 1711 also includes a first lens 1762 and a second lens 1764. First lens 1762 is seated within the first aperture 1722 and is positioned with its central lens axis 1772 directed perpendicular to the surface of the side wall at the centerline. Second lens 1764 is seated within second aperture 1724 and is positioned with its central lens axis 1774 is in a direction that is not perpendicular to the surface of the side wall at the centerline of the second lens 1764. A first fiber optic strand is coupled to first lens 1762 and a second fiber optic strand is coupled to second lens 1764. In one implementation, the first fiber optic strand may be in optical communication with an infrared sensor and the second fiber optic strand may be in optical communication with a photosensor. In another implementation, the first fiber optic strand may be in optical communication with a first photosensor and the second fiber optic strand may be in optical communication with a second photosensor.

In some cases, the sensor data measured by photosensors of the indoor sensor apparatus can be used as input to a sky dome model that is used to attenuate calculated clear sky irradiance. The attenuated clear sky data can be used to determine tint states for one or more tintable windows in the building. The sky dome model represents a luminance distribution from, for example, a celestial hemisphere representing the sky over the building. The sky dome model is discretized into a plurality of light patches (e.g., curved three-dimensional segments). Each light patch covers solid angles in azimuthal and altitudinal directions.

In one implementation, the housing of a fiber optic sky apparatus may be semi-hemispherical or multi-faceted and the fiber optic sky apparatus includes 145 fiber optic strands. The 145 fiber optic strands may be in 145 different directions aligned during installation to 145 sets of azimuth and altitude angles or may be coupled to 145 collection lenses. The 145 fiber optic strands are optically coupled to transmit light in one-to-one correspondence with 145 photosensors inside the building to take sensor data. The sensor data based on the light transmitted by the 145 fiber optic strands can be mapped in one-to-one correspondence to the 145 light patches of the sky dome model with the same angles.

FIG. 18 depicts a schematic diagram of a fiber optic apparatus 1801 that can be mounted or coupled to an exterior portion (e.g., roof or side) of a building. Fiber optic apparatus 1801 includes a housing 1811 having a hemispherical shape. The housing includes one hundred and forty five (145) apertures 1825 equally distributed along the outer surface of the housing 1811. The housing also includes 145 lenses 1865 seated within respective apertures 1825. Each of the lenses has a central lens axis 1875 has a direction that is perpendicular to the outer surface of the housing at the central lens axis 1875. The central lens axis of the 145 lenses 1865 are directed to 145 different sets of angles, e.g., 145 different sets of azimuthal and altitudinal angles. The 145 fiber optic strands are coupled to respective 145 lenses 1865. In some cases, the 145 fiber optic strands are in optical communication in one-to-one correspondence with 145 sensors inside the building. In one implementation, at least one of the fiber optic strands is in optical communication with an infrared sensor. In one implementation, the 145 fiber optic strands are in optical communication with respective 145 photosensors. In another implementation, one or more fiber optic strands are in optical communication with one or more infrared sensors and one or more fiber optic strands are in optical communication with one or more photosensors.

According to certain implementations, the sensor readings from sensors in optical communication with the fiber optic strands coupled to a fiber optic apparatus can be used as input to determine tint states for one or more optically switchable windows (e.g., electrochromic windows) in the building to which the fiber optic apparatus is mounted. For example, sensor readings from the sensors in optical communication with the fiber optic strands coupled to the 145 lenses 1865 in the fiber optic apparatus 1801 in FIG. 18 can be used as input to 145 light patches in a sky dome model.

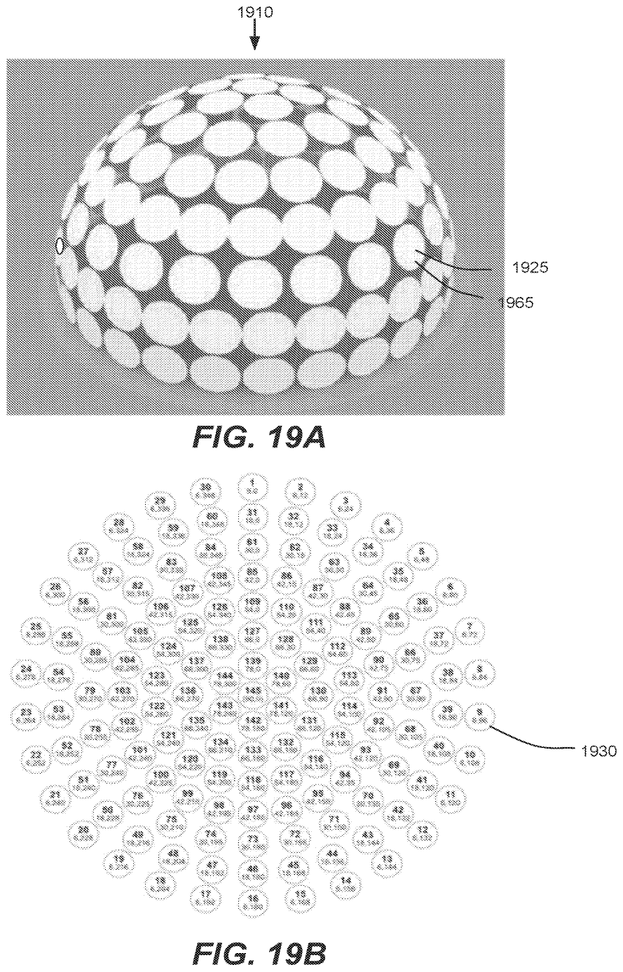

FIG. 19A is an illustration of a sky dome model 1910 having a plurality of 145 light patches 1925. In this illustration, the sky dome model 1910 has the shape of a hemisphere and the light patches are solid angle segments of the hemisphere, each segment covering solid angles in azimuthal and altitudinal directions. In this example, patches 1910 cover azimuthal/altitude solid angles of 0 degrees to 6 degrees, 6 degrees to 18 degrees, 18 degrees to 30 degrees, 30 degrees to 42 degrees, 42 degrees to 54 degrees, 54 degrees to 66 degrees, 66 degrees to 78 degrees, and 78 degrees to 90 degrees. In other examples, other solid angles may be covered by light patches. In addition or alternatively, other light patch shapes, numbers of light patches, and/or shape of the sky dome may be used. For example, solid angle rectangular segments of the hemisphere may be used. FIG. 19B is an illustration of a 2D projection of the sky dome 1910 in FIG. 19A. The 2D projection includes the light patch id number (1-145) for each light patch along with its azimuthal angle and altitude angle at the center or centroid of each light patch.

The sky dome model can be used to generate the illuminance distribution based on clear sky data attenuated by sensor readings to reflect dynamic changes (obstructions and reflections) in the sky. Various software, such as open source RADIANCE, may be used to generate clear sky data to initialize the illuminance values of the light patches of the sky dome. The clear sky data is calculated based on geographical location of the building (e.g., longitude, latitude, meridian) and time. Sensor data from one or more sensors may then be used to attenuate the clear sky data in the sky dome model to generate a real time sky dome model with real-time (or approximately real time) values based on attenuated clear sky data.

In certain aspects, to attenuate the clear sky data in the sky dome model, sensor readings of measured light data from the one or more sensors are used to determine an attenuation scaling factor applied to the illuminance values of the clear sky data for the light patches of the sky dome. For instance, at a particular time interval, the clear sky contribution of a light patch may be 500,000 lux. According to one or more photosensors a fiber optic sky sensor system, however, there are rain clouds in the portion of the sky represented by the light patch that causes the illuminance levels to be reduced from the clear sky value by approximately 70%. Based on these real-time sensor readings from the fiber optic sky sensor system, an attenuation scaling factor of 0.70 or higher may be determined and the scaling factor is applied to the illuminance value of the light patch. In some cases, the scaling factors are bound within a range such as, e.g., [0.2, 1], [0.5, 1]. Bounding the attenuation scaling factor to a range applies a conservative attenuation factor. For example, if a sensor is malfunctioning and reading 0 illuminance level, if the attenuation scaling factor is bound between [0.2, 1], an attenuation scaling factor of 0.20 is applied rather than 0.

In certain implementations, the real-time sky dome with attenuated clear sky data and a three-dimensional model of the building (e.g., a BIM file or a digital twin) with one or more tintable windows are used to predict the amount of light (e.g., natural light) at one or more grid points within the building. The real-time sky dome with attenuated clear sky data is used to determine an illuminance distribution of external light over the building and the individual contributions of its light patches. The three phase model and the three-dimensional virtual model of the building are used to determine the illuminance levels at one or more grid points internal to the building based on the illuminance contributions of the light patches in the real-time sky dome model that simulate external light to the building.

In one aspect, the real-time sky dome with attenuated clear sky data is based on clear sky data determined for a future time. For example, the clear sky data may be for a future time taking into account the transition time of the tintable window. The clear sky data may be determined for a future time so that a voltage profile can be applied to the tintable window in advance of the future time by at least the transition time to allow the tintable window to transition to the new tint state by the future time.

Although the foregoing embodiments have been described in some detail to facilitate understanding, the described embodiments are to be considered illustrative and not limiting. It will be apparent to one of ordinary skill in the art that certain changes and modifications can be practiced within the scope of the appended claims.

Modifications, additions, or omissions may be made to any of the above-described implementations without departing from the scope of the disclosure. Any of the implementations described above may include more, fewer, or other features without departing from the scope of the disclosure. Additionally, the steps of described features may be performed in any suitable order without departing from the scope of the disclosure. Also, one or more features from any implementation may be combined with one or more features of any other implementation without departing from the scope of the disclosure. The components of any implementation may be integrated or separated according to particular needs without departing from the scope of the disclosure.

Any of the software components or functions described in this application, may be implemented as software code using any suitable computer language and/or computational software such as, for example, Java, C, C#, C++ or Python, Lab VIEW, Mathematica, or other suitable language/computational software, including low level code, including code written for field programmable gate arrays, for example in VHDL. The code may include software libraries for functions like data acquisition and control, motion control, image acquisition and display, etc. Some or all of the code may also run on a personal computer, single board computer, embedded controller, microcontroller, digital signal processor, field programmable gate array and/or any combination thereof or any similar computation device and/or logic device(s). The software code may be stored as a series of instructions, or commands on a CRM such as a random access memory (RAM), a read only memory (ROM), a magnetic medium such as a hard-drive or a floppy disk, or an optical medium such as a CD-ROM, or solid stage storage such as a solid state hard drive or removable flash memory device or any suitable storage device. Any such CRM may reside on, or within, a single computational apparatus, and may be present on or within different computational apparatuses within a system or network. Although the foregoing disclosed implementations have been described in some detail to facilitate understanding, the described implementations are to be considered illustrative and not limiting. It will be apparent to one of ordinary skill in the art that certain changes and modifications can be practiced within the scope of the appended claims.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g., “such as”) provided with respect to certain implementations herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or implementations of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

1. A system comprising:
a housing configured to attach or mount to an exterior portion of a building;
a plurality of fiber optic strands at least partially positioned in the housing;
a plurality of lenses coupled to, within, and/or adjacent to the housing, wherein each lens is coupled to a proximal end of a corresponding fiber optic strand; and
a plurality of sensors, wherein distal ends of the fiber optic strands are configured for optical communication with the plurality of sensors.

2. The system of claim, wherein the plurality of sensors is located (i) inside the building or (ii) outside the building.

3. The system of claim, wherein the housing has a general shape of one of a cylinder, a hemisphere, a pyramid, a cube, a cuboid, a conical frustrum, a truncated sphere, a cross-section sphere, a four-prism, a hexagonal prism, a pyramid, or a spherical segment.

4. The system of claim, wherein the plurality of sensors comprises at least one photosensor and/or at least one infrared sensor.

5. The system of claim, wherein at least two of the lenses are positioned at different angles.

6. The system of claim, wherein the plurality of lenses comprises one or more of (i) one or more first lenses positioned radially outward from a central housing axis and (ii) one or more second lenses positioned in a direction substantially parallel to the central housing axis.

7. The system of claim, wherein:
the plurality of sensors comprises one or more photosensors and the plurality of lenses comprise one or more first lenses positioned radially outward from a central housing axis of the housing; and
the one or more first lenses are coupled to one or more first fiber optic strands of the plurality of fiber optic strands, the one or more first fiber optic strands in optical communication with the one or more photosensors.

8. The system of claim, wherein:
the plurality of sensors further comprises one or more infrared sensors and the plurality of lenses further comprise one or more second lenses positioned in a direction substantially parallel to the central housing axis;
the one or more second lenses are coupled to one or more second fiber optic strands of the plurality of fiber optic strands; and
at least one of the second fiber optic strands is in optical communication with the one or more infrared sensors.

9. The system of claim, wherein at least one of the second fiber optic strands is in optical communication with at least one of the one or more photosensors.

10. The system of claim, wherein at least a portion of each of the fiber optic strands passes through an interior space of the housing.

11. The system of claim, wherein the housing is configured to couple to a mounting element, the mounting element attached or configured to attach to the building.

12. The system of claim, wherein each of the lenses is located within, or adjacent to, a light transmissive region in the housing.

13. The system of claim, wherein the light transmissive region is an aperture comprising an opaque material and/or a filter.

14. The system of claim, wherein the plurality of fiber optic strands includes a first set of fiber optic strands and a second set of fiber optic strands optically connected to the first set of fiber optic strands.

15. The system of claim, wherein the first set of fiber optic strands is optically connected to the second set of fiber optic strands via one or more optical connectors.

16. An apparatus comprising:
a plurality of fiber optic strands, wherein:
a proximal end of each fiber optic strand is located exterior to a building, and
a distal end of each fiber optic strand is configured for optical communication with one corresponding sensor of a plurality of sensors, the plurality of sensors located inside the building; and
a plurality of lenses, wherein each lens is optically coupled to a corresponding fiber optic strand.

17. The apparatus of claim, wherein the distal end of each fiber optic strand is configured for optical communication with a corresponding photosensor of the plurality of sensors.

18. The apparatus of claim, wherein:
a first distal end of a first fiber optic strand of the plurality of fiber optic strands is configured for optical communication with a corresponding photosensor of the plurality of sensors; and
a second distal end of a second fiber optic strand of the plurality of fiber optic strands is configured for optical communication with a corresponding infrared sensor of the plurality of sensors.

19. The apparatus of claim, wherein at least two lenses of the plurality of lenses are positioned at different angles.

20. The apparatus of claim, wherein the plurality of lenses comprises one or more of (i) one or more first lenses positioned radially outward from a central housing axis of the apparatus or (ii) one or more second lenses positioned in a direction substantially parallel to the central housing axis.

21-51. (canceled)
